(19) United States
(12) Patent Application Publication
(10) Pub. No.: US 2009/0030960 A1
(43) Pub. Date: Jan. 29, 2009

(54) Data processing system and method

(76) Inventors: Dermot Geraghty, Dulin 20 (IE); David Moloney, Dublin 9 (IE)

Correspondence Address: JACOBSON HOLMAN PLLC, 400 SEVENTH STREET N.W., SUITE 600, WASHINGTON, DC, 20004, US

(21) Appl. No.: 11/920,244

(22) PCT Filed: May 15, 2006
(86) PCT No.: PCT/IE2006/000058

§ 371 Date: Nov. 13, 2007

(30) Foreign Application Priority Data
May 13, 2005 (IE) 2005/0312

(51) Int. Cl. G06F 17/16; G06F 7/52

(52) U.S. Cl. 708/203

(57) ABSTRACT

A matrix by vector multiplication processing system (1) comprises a compression engine (2) for receiving and dynamically compressing a stream of elements of a matrix; in which the matrix elements are clustered, and in which the matrix elements are in numerical floating point format, and a memory (SDRAM, 3) for storing the compressed matrix. It also comprises a decompression engine (4) for dynamically decompressing elements retrieved from the memory (3), and a processor (10) for dynamically receiving decompressed elements from the decompression engine (3), and comprising a vector cache (13, 19), and multiplication logic (12, 21) for dynamically multiplying elements of the vector cache with the matrix elements. There is a cache (13) for vector elements to be multiplied by matrix elements to one side of a diagonal, and a separate cache or register (19) for vector elements to be multiplied by matrix elements to the other side of the diagonal. A control mechanism (16, 17, 18) multiplies a single matrix element by a corresponding element in one vector cache and separately by a corresponding element in the other vector cache. The compression engine and the decompression logic are circuits within a single integrated circuit, and the compression engine (2) performs matrix element address compression by generating a relative address for a plurality of clustered elements.

### FIELD OF THE INVENTION

The invention relates to data processing and to processes controlled or modelled by data processing. It relates particularly to data processing systems performing matrix-by-vector multiplication, such as sparse matrix-by-vector multiplication (SMVM).

### PRIOR ART DISCUSSION

There are several applications which require matrix-by-vector multiplication, such as finite element modelling (FEM) or internet search engine applications. (U.S. Pat. No. 5,206,822 (Taylor) describes an approach to processing sparse matrices, in which matrix elements are streamed from a memory into a processor cache as a vector. It also describes a new representation for a sparse matrix which was more compact and more efficient than other known representations. Matrix columns are delineated in the vector (or “stream”) by zeroes. Once the vector is written to the cache, hardware logic elements of the circuit perform the multiplication.

While this matrix representation is efficient in terms of space, the multiplication operations are vulnerable to cache misses, as an element missing from the cache can cause many tens of processor cycles to be wasted in performing a retrieval from memory.

An object of the invention is to achieve improved data processor performance for large-scale finite element processing. More particularly, the invention is directed towards achieving, for such data processing:
reduced memory requirements, and/or
reduced bandwidth requirements, and/or
increased Floating-Point Operations per Second (FLOPs), and/or
improved data compression and indexing of compressed data, and/or reduced start-up time.

### SUMMARY OF THE INVENTION

According to the invention, there is provided a matrix by vector multiplication processing system comprising:
a compression engine for receiving and dynamically compressing a stream of elements of a matrix; in which the matrix elements are clustered, and in which the matrix elements are in numerical floating point format;
a memory for storing the compressed matrix;
a decompression engine for dynamically decompressing elements retrieved from the memory; and
a processor for dynamically receiving decompressed elements from the decompression engine, and comprising a vector cache, and multiplication logic for dynamically multiplying elements of the vector cache with the matrix elements.

In one embodiment, the processor comprises a cache for vector elements to be multiplied by matrix elements above a diagonal and a separate cache for vector elements to be multiplied by matrix elements below the diagonal, and a control mechanism for multiplying a single matrix element by a corresponding element in one vector cache and separately by a corresponding element in the other vector cache.

In one embodiment, the vector elements are time-division multiplexed to a multiplier.

In one embodiment, the multiplication logic comprises parallel multipliers for simultaneously performing both multiplication operations on a matrix element.

In one embodiment, the processor comprises a multiplexer for clocking retrieval of the vector elements.

In one embodiment, the compression engine and the decompression logic are circuits within a single integrated circuit.

In one embodiment, the compression engine performs matrix element address compression by generating a relative address for a plurality of clustered elements.

In one embodiment, the compression engine keeps a record of row and column base addresses, and subtracts these addresses to provide a relative address.

In one embodiment, the compression engine left-shifts an address of a matrix element to provide a relative address.

In one embodiment, the left-shifting is performed according to the length of the relative address.

In one embodiment, the compression engine comprises a relative addressing circuit for shifting each address by one of a plurality of discrete options.

In one embodiment, the relative addressing circuit comprises a length encoder having one of a plurality of outputs decided according to address length.

In one embodiment, the relative addressing circuit comprises a plurality of multiplexers implementing hardwired shifts.

In another embodiment, the compression engine compresses a matrix element by eliminating trailing zeroes from each of the exponent and mantissa fields.

In one embodiment, he compression engine comprises means for performing the following steps:
recognizing the following patterns in the non-zero data entries:
   +/−1s which can be encoded as an opcode and sign-bit only,
   power of 2 entries consisting of a sign, exponent and all zero mantissa, and
   entries which have a sign, exponent and whose mantissa contains trailing zeroes; and
performing the following operations::
   forming an opcode by concatenating opcode_M, AL and ML bit fields,
   forming the opcode, compressed delta-address, sign, exponent and compressed mantissa into a compressed entry, and
   left-shifted the entire compressed entry in order that the opcode of the compressed data resides in bit N-1 of an N-bit compressed entry.

In one embodiment, the compression engine comprises inserts compressed elements into a linear array in a bit-aligned manner.

In one embodiment, the decompression engine comprises packet-windowing logic for maintaining a window which straddles at least two elements.

In one embodiment, the decompression logic comprises a comparator which detects if a codeword straddles two N-bit compressed words in memory, and logic for performing the following operations:
in the event a straddle is detected a new data word is read from memory from the location pointed to by entry_ptr+1and the data-window is advanced, otherwise the current data-window around entry_ptr is maintained in the two N-bit registers, and
concatenating the contents of the two N-bit registers into a single 2N-bit word which is shifted by bit positions to the left in order that the opcode resides in the upper set of bits of the extracted N-bit field so the decompression process can begin.

In one embodiment, the decompression engine comprises data masking logic for masking off trailing bits of packets.

In one embodiment, the decompression engine comprises data decompression logic for multiplexing in patterns for trivial exponents.

In another aspect, the invention provides a data processing method for performing any of the above data processing operations.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1(a) is a high level representation of a data processing system of the invention, and FIG. 1(b) is a block diagram of a data processor of the system;

FIGS. 2 and 3 are diagrams illustrating matrix storage and cache access patterns;

FIG. 4 is a block diagram of an alternative data processor;

FIG. 5 is a flow diagram illustrating compression logic;

FIG. 6 is a diagram illustrating bit-width reduction using relative addressing;

FIG. 7 is a diagram of compression delta-address logic;

FIG. 8 is a diagram of decompression delta-address logic;

FIG. 9 shows programmable delta-address calculation;

FIG. 10 shows delta-address length encoder logic;

FIG. 11 shows complete address encode/compression logic;

FIG. 12 shows address encode/compression logic with optimised shifter;

FIG. 13 shows non-zero data-compression logic;

FIG. 14 shows data-masking logic;

FIG. 15 shows data-concatenation opcode insertion;

FIG. 16 shows compressed entry insertion mechanism;

FIG. 17 shows compressed data insertion logic;

FIG. 18 shows a decompression path;

FIG. 19 shows data/address decompression windowing;

FIG. 20 shows packet-windowing logic;

FIG. 21 shows decompression pre-fetch buffering;

FIG. 22 shows decompression control logic;

FIG. 23 shows address decompression logic;

FIG. 24 shows a data-decompression alignment shifter;

FIG. 25 shows a data decompression-masking opcode decoder;

FIG. 26 shows data decompression masking logic;

FIG. 27 shows data decompression selection logic;

FIG. 28 shows effect of AL encoding on compression;

FIG. 29 shows an alternate opcode/address/data format to simplify compression and decompression;

FIG. 30 shows datapath parallelism;

FIG. 31 shows a parallel opcode decoder;

FIG. 32 shows an optimised architecture;

FIG. 33 shows an optimised FPU;

FIG. 34 shows SMVM column-major matrix-multiplication;

FIG. 35 shows processing delay between SMVM and dot-product;

FIG. 36 shows SMVM to chained FPU signaling logic;

FIG. 37 shows embodiment of combined SMVM and dot-product unit;

FIG. 38 shows a method of initialising vector cache/memory;

FIG. 39 shows vector cache-line initialisation; and

FIG. 40 shows parallelism and L2 cache.

The invention reduces the time taken to compute solutions to large finite-element and other linear algebra kernel functions. It applies to Matrix by Vector Multiplication such as Sparse Matrix by Vector Multiplication (SMVM) computation which is at the heart of finite element calculations but is also applicable to Latent Semantic Indexing (LSI/LSA) techniques used for some search engines and to other techniques such as PageRank use for internet Search engines. Examples of large finite-element problems occur in civil engineering, aeronautical engineering, mechanical engineering, chemical engineering, nuclear physics, financial and climate modelling as well as mathematics, astrophysics and computational biochemistry.

The invention accelerates the key performance-limiting SMVM operation at the heart of these applications. It also provides a dedicated data path optimised for these applications, and a streaming memory compression and decompression scheme which minimizes storage requirements for large data sets. It also increases system performance by allowing data sets to be transferred more rapidly to/from memory.

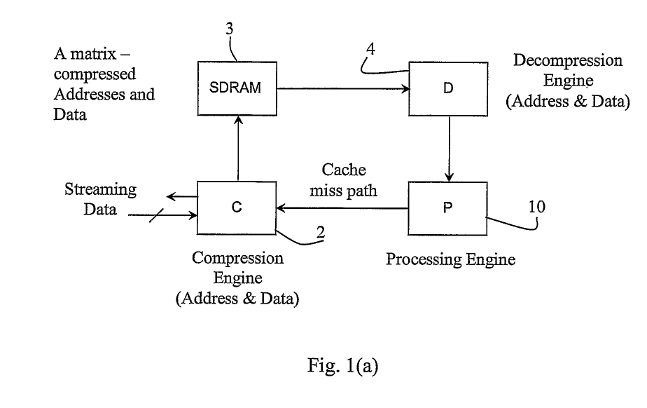

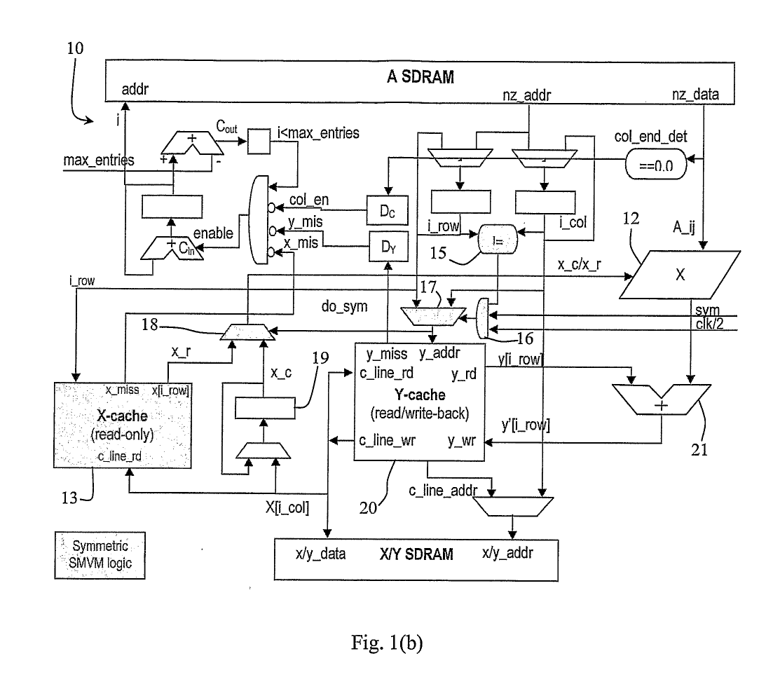

Referring to FIG. 1(a) a data processing system 1 comprises a compression circuit 2 for on-the-fly compression of a stream (or “vector”) of matrix elements in a representation such as a SPAR representation. The compressed elements are written to an S-DRAM 3 which stores them for multiplication processing. A decompression circuit 4 on-the-fly decompresses the data for a data processor 10, which performs the multiplication.

The invention pertains particularly to the manner in which compression and decompression is performed, and also to the manner in which the data processor 10 operates.

Referring to FIG. 1 (b) a data processor 10 has, in general terms, a Sparse Matrix Architecture and Representation (“SPAR”) format, enhanced considerably to efficiently exploit symmetry in a matrix both in terms of reduced storage and more efficient multiplication. An X-register 19 is in parallel with an X-cache 13. In FIG. 1 an A SDRAM 3 and an X/Y SDRAM are off-chip memory devices, the chip 10 having the logic components shown between these two memories. These components interface with external floating point co-processors and the SDRAM memory devices 3. The logic components handle a symmetric storage scheme very efficiently. A comparator 15 having i_row and i_col inputs determines whether the element is above or below the matrix diagonal (if not equal, not on the diagonal). An AND gate 16 fed by this comparator 15 has a two half clock cycle input. An output from the AND gate to a multiplexer 17 allows an unsymmetric multiplication in the first half clock cycle and a symmetric multiplication in the second half clock cycle. The multiplexer switches between the X register value and the X cache 13, avoiding need for external reads/writes and hence improving performance.

A single Y-cache 20 and MAC unit 12/21 are time-shared between the symmetric and unsymmetric halves of the matrix multiplication by running the MAC at half the rate of the cache and multiplexing between X row and column values and Y row column values. The design is further optimised by taking advantage of the fact that the A_ij multiplier path is used twice. Using the A_ij data to generate either shifted partial-products if A_ij is the multiplicand or Booth-Recoding using A_ij if it is the multiplier and storing these values for use in the symmetric multiplication could reduce power-dissipation in power-sensitive applications.

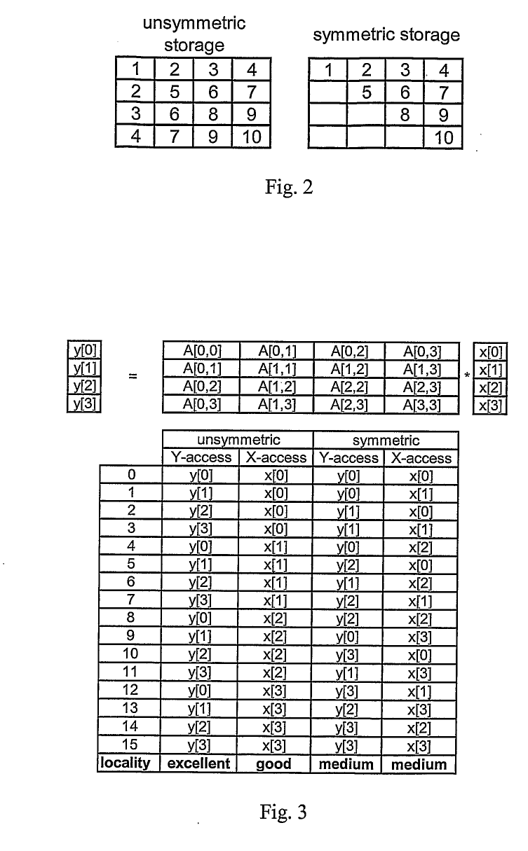

Storing matrices in symmetric format results in approximately half the storage requirements and half the memory bandwidth requirements of a symmetric matrix stored in unsymmetric format, i.e. in symmetric format only those non-zero entries on or above the diagonal need be stored explicitly, as shown in FIG. 2.

Advantageous aspects of the data processor 10 include the fact that the multiplexer 17 controls whether a symmetric multiplication is being performed, providing the clk/2 signal the edges of which trigger retrievals from the X-cache 13 and the X-register 19. Also, the multiplexer 18 effectively multiplexes the X-cache 13 and X-register 19 elements for multiplication by the MAC 12/21. Thus, with cost in processor activity, the same matrix element value is in succession multiplied by the X vector element for the top diagonal position and by the X-vector value for the bottom diagonal position of the matrix element value.

The architecture of the processor 10 takes advantage of the regularity of access patterns when a matrix is stored and accessed in column normal format to eliminate a second cache which would otherwise be required in such an architecture. In other words, the locality of X memory access is so good that only a register need be provided rather than a cache as shown in the 4×4 SMVM in FIG. 3. As can be seen from the same table in the case of symmetric matrices stored in redundant (non-symmetric) SPAR format whereas the X access-pattern is highly regular, the Y access pattern is highly irregular. By contrast, if the same matrix data is stored in irredundant SPAR format the X access pattern is much less regular than before meaning that an additional X-cache is required for good performance. However, again in comparison to unsymmetric storage the irredundant storage pattern exhibits much better Y-cache locality.

This architecture leads to a reduced area design and is particularly useful in process technologies where the design is limited by memory bandwidth rather than the internal clock rate at which the functional units can run. Time-sharing the cache between upper and lower halves of a symmetric matrix (above and below the diagonal) in this way eliminates any possible problems of cache-coherency as the possibility of cache-entries being modified simultaneously is eliminated by the time-sharing mechanism. The same arrangement can be used to elaborate both symmetric and unsymmetric matrices under the control of the sym input in that all time-sharing and the lower-diagonal multiplication logic are disabled while the sym input is held low, thus saving power where symmetry cannot be exploited. Exploiting matrix symmetry in the manner described allows the processing rate of the SPAR unit of the invention to be approximately doubled compared to prior art SPAR architectures, while maintaining the same memory bandwidth and halving matrix storage requirements.

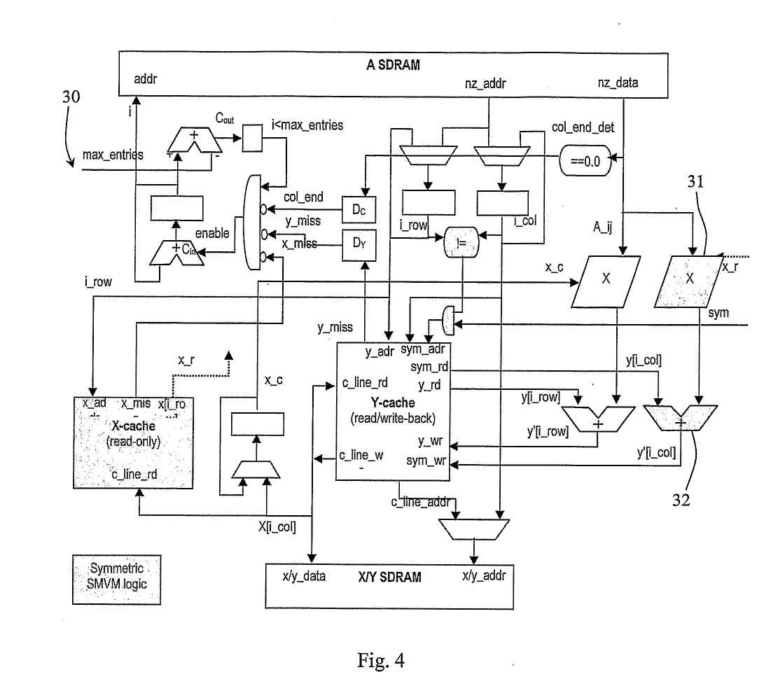

An alternative processor 30, shown in FIG. 4, demonstrates another method of exploiting matrix symmetry. This adds a second MAC unit 31/32 and a second pair of read/write ports to the SPAR multiplier. This technique trades off increased area against a lower clock-speed. The symmetric MAC runs in parallel with the unsymmetric MAC with both MAC units producing a result on each clock cycle, rather that on alternate cycles as shown in FIG. 1(b). The logic involved in the elaboration of symmetric matrices is again shaded for clarity and its operation is controlled by bringing the sym input high for the duration of the sparse-matrix vector multiplication (SMVM). While in a more general purpose computer architecture sharing a cache between two functional units can create cache coherence problems which must be resolved or avoided, in this case there are no such coherency problems as x[i_row] (x_r) and x[i_col] (x_c), as well as y_r and y_c never conflict because the symmetric portion of the multiplier references different y values due to the row/col index inequality check in line 12 of FIG. 3.

Matrix Compression Logic (Components 2 & 4 of FIG. 1 (a))

Matrix compression is performed in a streaming manner on the matrix data as it is downloaded to the processor 10 in a single pass rather than requiring large amounts of buffer memory allowing for a low cost implementation with minimal local storage and complexity. Whereas in principle the compression can be implemented in software, in practice this may become a performance bottle-neck given the reliance of the compression scheme on the manipulation of 96-bit integers which are ill-suited to a microprocessor with a 32-bit data-path and result in rather slow software compression. The complete data-path for hardware streaming sparse-matrix compression is shown in FIG. 5.

The matrix compression logic consists of the following distinct parts:
Delta-Address Calculation
Address Compression
Data Masking
Compressed Entry Insertion (Write)
Compressed Entry Retrieval (Read)

Operation of the compression circuit 2 is on the basis of “delta” addressing matrix elements which are clustered. In this embodiment, clustering is along the diagonal, however the compression (and subsequent decompression) technique to a stream of sparse matrix elements which are clustered in any other manner, or indeed non-sparse matrices. The non-clustered (outlier) elements are absolute-addressed. As regards the data values, these are numerical floating point values having 64 bits:
1-bit sign;
11-bit exponent; and
52-bit mantissa.

Compression of the values includes deleting trailing zeroes of each of the exponent and mantissa fields of each element.

An important aspect is that the lossless data compression and de-compression is performed on-the-fly in a streaming manner. Using data compression leads to increased memory bandwidth.

### Delta-Address Logic

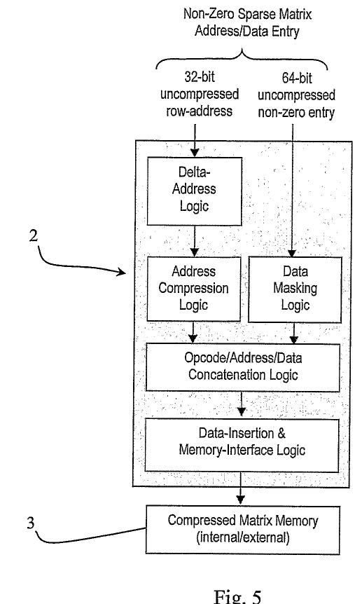

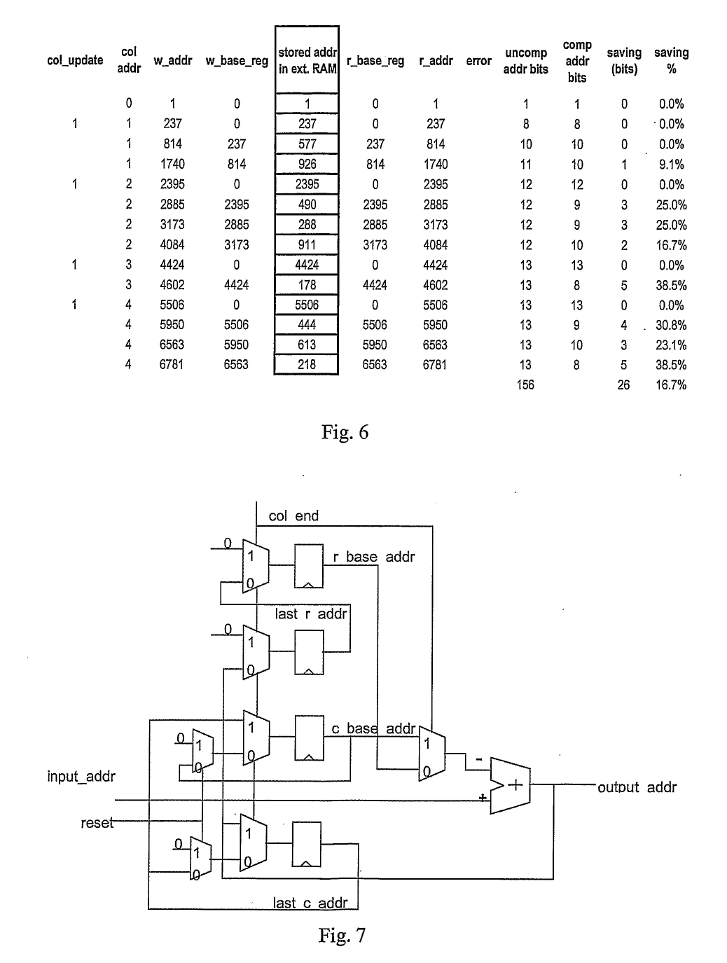

A simple relative addressing scheme for SMVM is illustrated in FIG. 6. As can be seen the savings from such a scheme are significant and are easily implemented in hardware, both in terms of conversion from absolute to relative addresses and vice versa.

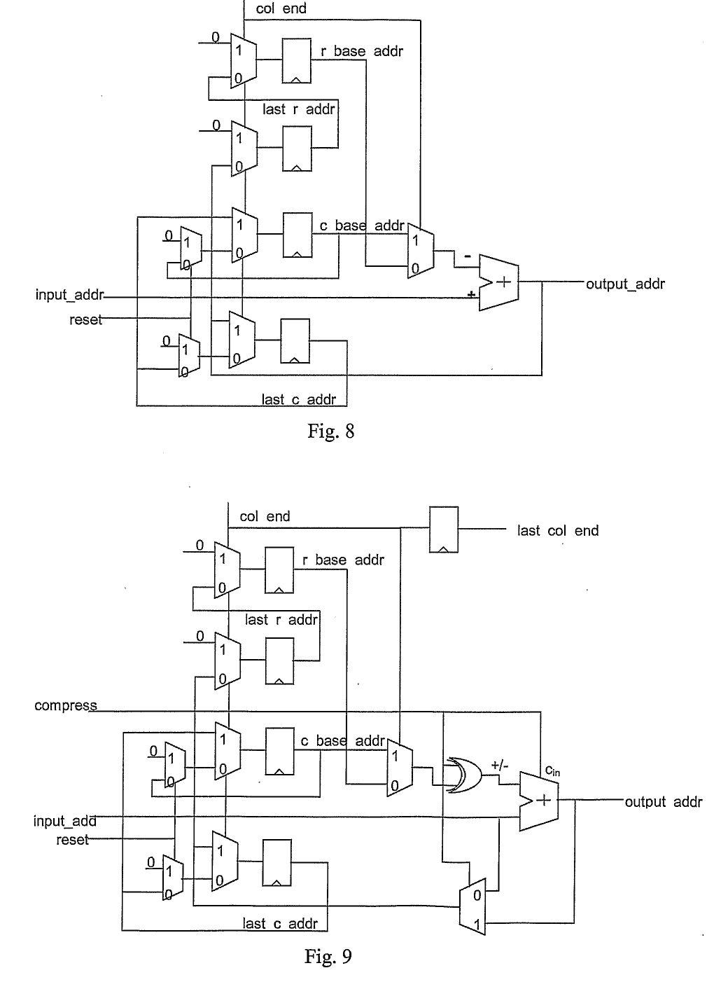

The delta address calculation logic consists of two parts, delta-address compression logic and delta-address decompression logic. These parts can be implemented as two separate blocks as shown in FIG. 7 and FIG. 8 or as one combined block programmable for compression and decompression as shown in FIG. 9.

The Delta-Address Compression logic shown in FIG. 7 keeps a record of the row and column base addresses as row or column input addresses are written to the block. These base addresses are then subtracted from the input address to produce an output delta-address under the control of the col_end input so the correct delta-value is produced in each case. Subtracting addresses in this manner ensures that the minimum memory possible is used to store address information corresponding to row or column entries as only those bits which change between successive entries need be stored rather than the complete address.

Both compression and decompression logic can be accommodated within the single programmable block shown in FIG. 9.

A single programmable block can be used in the event all matrix compression/decompression is to be performed within the FIAMMA accelerator in order to hide details of the FIAMMA format from the host and any software applications running on it. Otherwise, if it is desired that the host take advantage of the compressed FIAMMA format in order to more rapidly up/download matrix data to/from the host a second such block or the matrix compression part alone can be implemented on the host in either hardware or software. Thus the matrix can be compressed in a streaming fashion on the host side as it is being downloaded to the accelerator, or alternately decompressed in a streaming fashion as the compressed matrix data arrives across the accelerator interface.

### Address Compression & Data-Masking Logic

The first stage in the compression of the address/non-zero sparse-matrix entries is to compress the address portion of the entry. The scheme employed is to determine the length of the delta-address computed previously so that the address portion of the compressed entry can be left-shifted to remove leading zeroes. Given the trade-off between encoding overhead and compression efficiency following extensive simulation it was decided that rather than allowing any 0-26-bit shift of the delta-address the shifts would be limited to one of four possible shifts. This both limits the hardware complexity of the encoder but also results in a higher compression factor being achieved overall for the matrix database used to benchmark the architecture.

Before a shift to remove redundant leading bits in the delta-address can be performed the length of the quantised shift required must first be computed as shown below.

Delta-Address Length Encoder

1> addr_bits = log_2(a_ij.addr);
2> if (addr_bits>19) addr_comp = 3;
3> else if (addr_bits>11) addr_comp = 2;
4> else if (addr_bits> 3) addr_comp = 1;
5> else addr_comp = 0;
6> q_addr_bits = al_len[addr_comp];
7> v_addr = (a_ij.addr & ((1<<q_addr_bits)−1));

In line 1 a leading-one detection is performed and rounded up to the next highest power of 2 to allow for the trailing bits in the address (achieved by adding an offset of 1 to the position of the leading one). The addr_bits signal generated by the LOD is then compared using 3 magnitude comparators to identify the shift range required to remove leading ones, and finally the outputs of the comparators are combined as shown in the table below to produce a 2-bit code.

Delta-Address Encoder Truth-Table

addr_comp

| addr > 19 | addr > 11 | addr > 3 | [1] | [0] |
|---|---|---|---|---|
| 1 | 0 | 0 | 1 | 1 |
| 0 | 1 | 0 | 1 | 0 |
| 0 | 0 | 1 | 0 | 1 |
| 0 | 0 | 0 | 0 | 0 |

The 2-bit code word can then be used to control a programmable shifter which removes leading zeroes in the delta-address by left-shifting the delta-address word. The logic required to implement the delta-address length encoder is shown in FIG. 10.

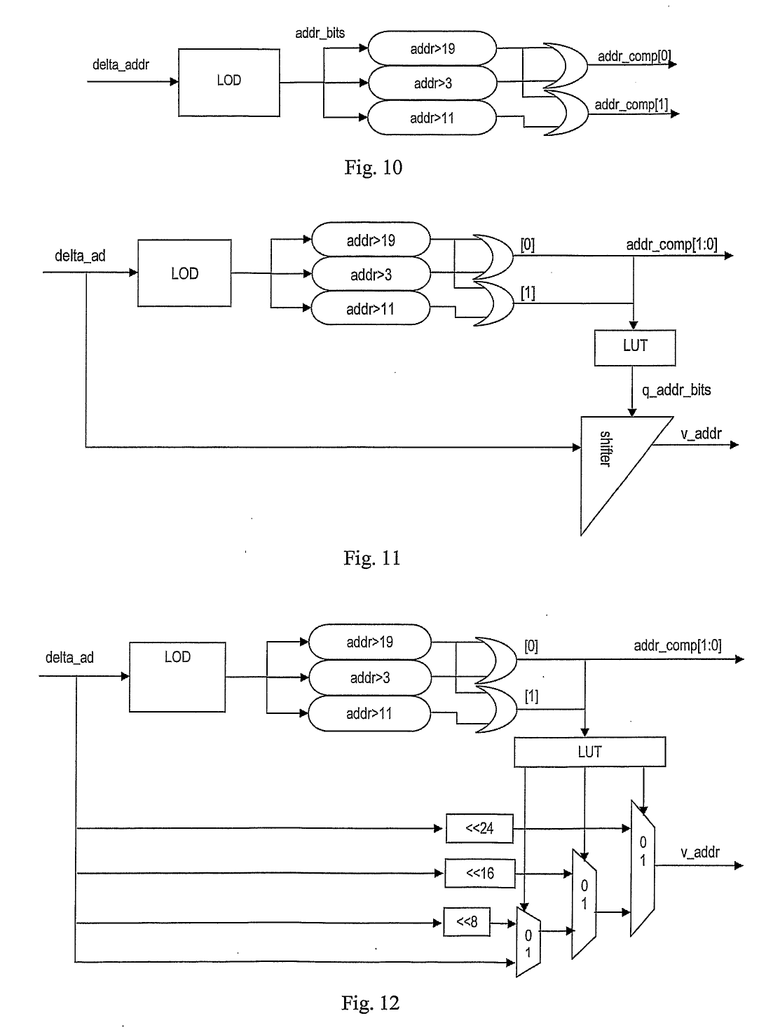

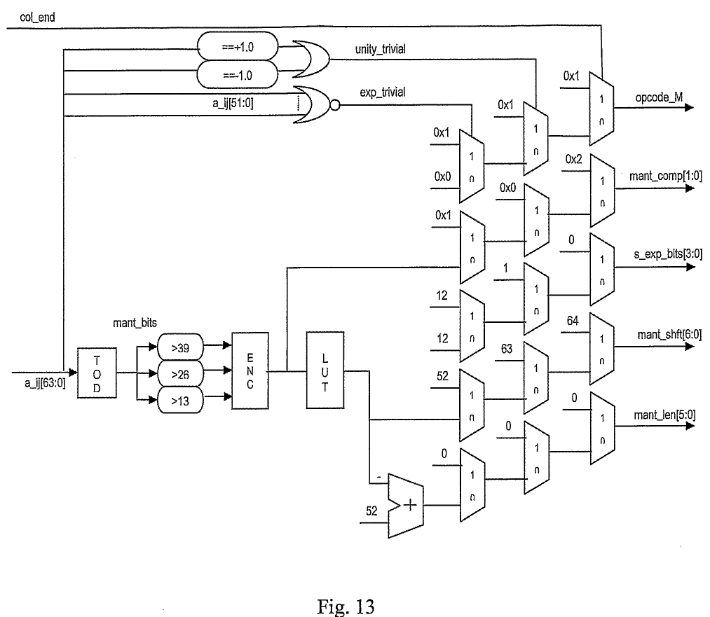

The complete diagram of the delta-address compression logic is shown in FIG. 11. One advantage of the address-range quantisation scheme is that the shifter consists of 4 multiplexers implementing 3 simple hardwired shifts rather than a complex bit-programmable shifter with many more multiplexers which would be required if any shift in the range 0-26 bits were used in the compression scheme.

The complete address encoder/compressor with simplified shifter is shown in FIG. 12. This configuration will typically only be used where system simulations have shown there to be one set of optimal shifts common to all data sets which give optimal compression across the entire data set. If a more flexible scheme is required with adaptive encoding it makes more sense to have a completely programmable shifter as will be shown later.

The next step in the compression process is to compress the non-zero data entries. This is done by recognizing patterns in the non-zero data entries:
+/−1s which can be encoded as an opcode and sign-bit only
Power of 2 entries consisting of a sign, exponent and all zero mantissa
Entries which have a sign, exponent and whose mantissa contains trailing zeroes

The final stage in the data-compression path is the data-compaction logic, in which the following actions are performed:
opcode is formed by concatenating opcode_M, AL and ML bit fields
the opcode, compressed delta-address, sign, exponent and compressed mantissa are formed into a compressed entry
the entire compressed entry is left-shifted in order that the opcode of the compressed data resides in bit 95 of the 96-bit compressed entry

Looking at the opcode/addr/data as packets simplifies task of opcode concatenation:
Masking of sign/exp/mant deletes trailing 0s
   Trivial +/−1s: 63-bits
   Trivial Exps: 52-bits
   VAM: 39-bits, 26-bits, 13-bits, 0-bits
4 shifts required for concatenated addr/data
   24 bits
   16 bits
   8 bits
   0 bits
   Opcode ORed into leading 5-bits [95:91]

The truth-table required to support the data-masking required in the opcode concatenation logic is shown below.

Truth-Table for Data Masking Control Logic

| | | | | | | | | | | | | | expo- | | | | |
|---|---|---|---|---|---|---|---|---|---|---|---|---|---|---|---|---|---|
| M | AL | | ML | | opcode | en_s | en_exp | en_m11 | en_m10 | en_m01 | en_m00 | sign | nent | mantissa | | | |
| 0 | x | x | 1 | 1 | VAM | 1 | 1 | 1 | 1 | 1 | 1 | s | 11-bit | 13-bits | 13-bits | 13-bits | 13-bits |
| 0 | x | x | 1 | 0 | | 1 | 1 | 1 | 1 | 1 | 0 | s | 11-bit | 13-bits | 13-bits | 13-bits | |
| 0 | x | x | 0 | 1 | | 1 | 1 | 1 | 1 | 0 | 0 | s | 11-bit | 13-bits | 13-bits | | |
| 0 | x | x | 0 | 0 | | 1 | 1 | 1 | 0 | 0 | 0 | s | 11-bit | 13-bits | | | |
| 0 | x | x | 0 | 0 | TRU | 1 | 0 | 0 | 0 | 0 | 0 | s | | | | | |
| 1 | x | x | 0 | 1 | TRE | 1 | 1 | 0 | 0 | 0 | 0 | s | 11-bit | | | | |
| 1 | x | x | 1 | 0 | CLU | 0 | 0 | 0 | 0 | 0 | 0 | | | | | | |
| 1 | x | x | 1 | 1 | RES | 0 | 0 | 0 | 0 | 0 | 0 | | | | | | |

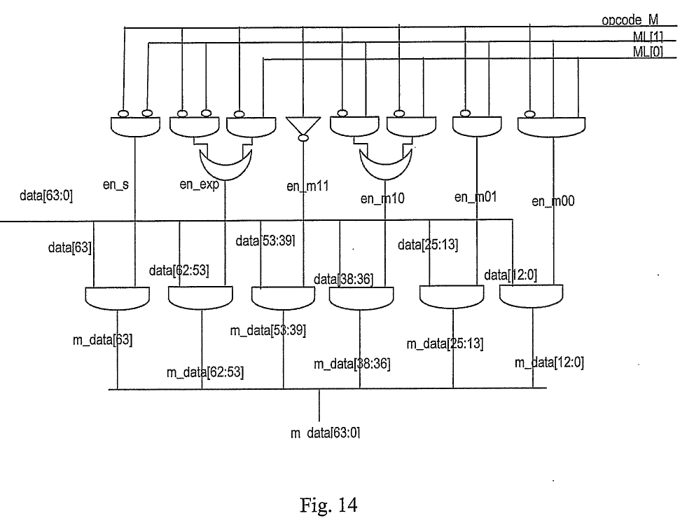

The complete data masking logic block, including the data-masking control logic which controls the opcode masking logic diagram is shown in FIG. 14. Here the M and ML[1:0] bits from the opcode are used to mask the sign, exponent and four 13-bit subfields of the mantissa selectively depending on the opcode so the trailing data bits are zeroed out and can be overwritten by the following compressed opcode/address/data packet.

The next stage in the opcode concatenation logic performs a programmable left-shift to remove leading zeroes in the delta-address identified by the Leading-One-Detector (LOD). The same shifter also shifts the masked data. The truth-table for the programmable shifter is given below.

Data Concatenation Shifter Truth-Table

| M | AL | | ML | | shift | shift_24 | shift_16 | shift_8 | Shifted Delta-Address Pattern | | | | |
|---|---|---|---|---|---|---|---|---|---|---|---|---|---|
| x | 1 | 1 | x | x | 0 | 0 | 0 | 0 | 3-bit | 8-bit | 8-bit | 8-bit | 32 |
| x | 1 | 0 | x | x | 8 | 0 | 0 | 1 | 3-bit | 8-bit | 8-bit | 24 | |
| x | 0 | 1 | x | x | 16 | 0 | 1 | 0 | 3-bit | 8-bit | 16 | | |
| x | 0 | 0 | x | x | 24 | 1 | 0 | 0 | 3-bit | 8 | | | |

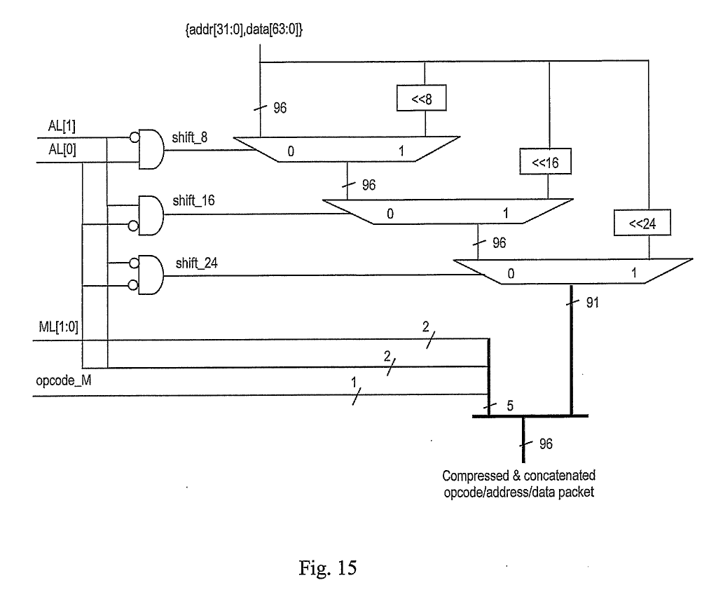

The modified concatenation shifter to perform the required shifts of the combined address/data packets to remove loading zeroes from the address portions of the packets, with integrated opcode insertion logic is shown in FIG. 15. The AL[1:0] field of the opcode is used to shift the masked data left by 0,8, 16 or 24 bits respectively to take account of the leading zeroes removed from the delta-address field. The final addition to the compressed packet-formation process is to overwrite the leading 5 unused address bits with the 5-bit opcode so that the opcode bits appear in the 5 most-significant bits (MSBs) of the compressed 96-bit packet. Here no OR gate is required as the 5 leading bits of the address field are always zeroes (delta-address are limited to 27-bits) and can be discarded and replaced by the 5-bit opcode field in the 5 MSBs.

### Compressed Entry Insertion Logic

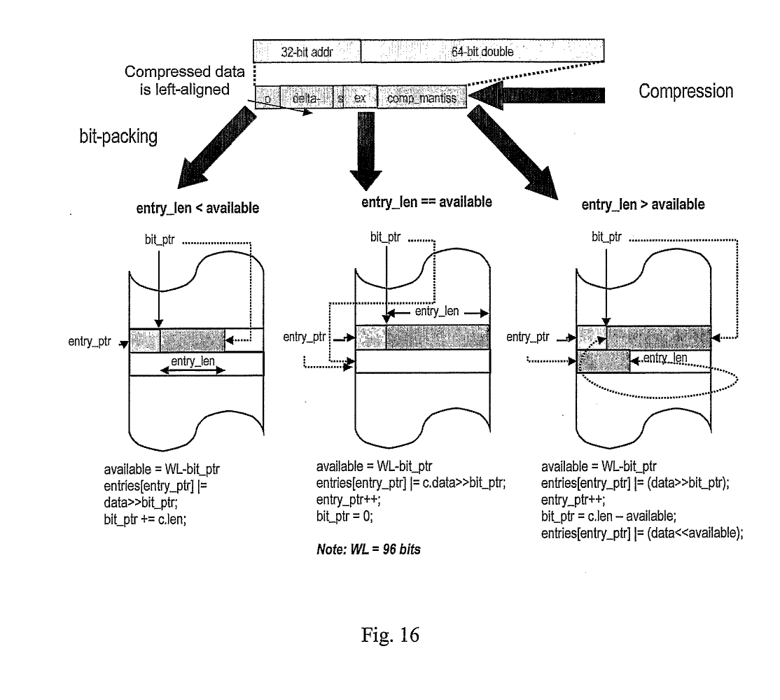

Once an address/data entry has been compressed into a shortened format is must be inserted into the FIAMMA data-structure in memory. The FIAMMA data-structure is a linear array of 96-bit memory entries and in order to achieve maximum compression each entry must be shifted so it is stored in a bit-aligned manner leaving no unused space between it and the previous compressed entry stored in the FIAMMA array. As can be seen from FIG. 16 there are three cases which can occur in inserting a compressed address/non-zero word into a 96-bit word within the FIAMMA data-structure in memory:
The compressed entry when inserted leaves space for a following entry within the current 96-bit FIAMMA entry.
The compressed entry when inserted fills all of the available bits within the current 96-bit word.
The available bits in the current FIAMMA 96-bit memory word are not sufficient to hold the compressed entry and part of the compressed entry will have to straddle into the next 96-bit FIAMMA memory location.

The graphical view of the matrix insertion logic can be translated into equivalent program code as shown below.

Compressed Entry Insertion

| 3> | available = 96 − bit_ptr; | // how many bits out of the 96 are |
|---|---|---|
| | free? | |
| 4> | entries[this->entry_ptr] \|= (data>>bit_ptr); // insert segment into current word | |
| 5> | if (len < available) { | // word doesn't fill available bits |
| 6> | bit_ptr += len; | |
| 7> | } | |

| | | |
|---|---|---|
| 8> | else if (len == available) { | // word fills available bits |
| 9> | entry_ptr++; | // advance to next 96-bit word |
| 10> | bit_ptr = 0; | // start @ bit0 of 96-bit word |
| 11> | } | |

| | | |
|---|---|---|
| 12> | else if (len > available) { | // word needs > available bits |
| 13> | entry_ptr++; | // advance to next 96-bit word |
| 14> | bit_ptr = len − available; | // length of straddle |

| | |
|---|---|
| 15> | entries[entry_ptr] \|= (data<<available); // insert straddle into next word |
| 16> | } |
| 17> | max_entries++; // update fiamma entry-count each time a compressed entry is |
| | inserted!! |

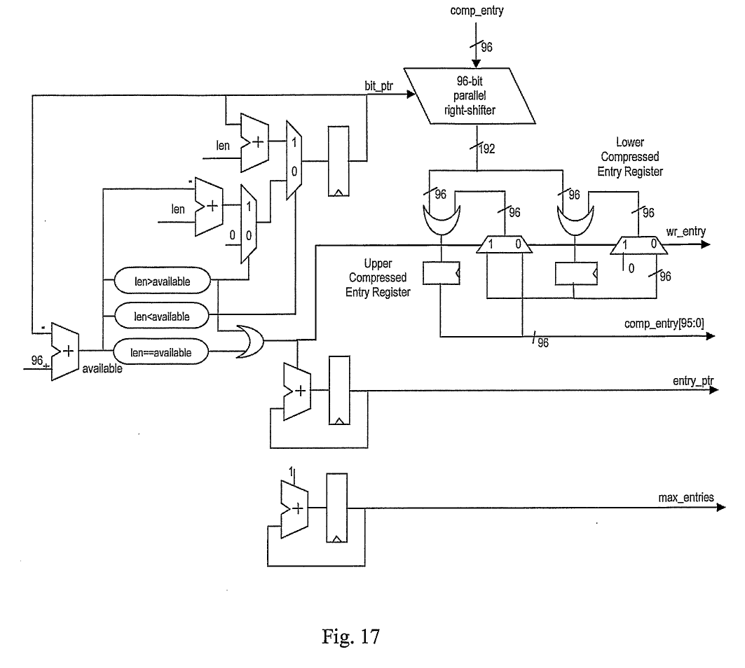

One point to note is that the compressed entry insertion mechanism is independent of the actual compression method utilised and hence other compression schemes could in principle be implemented using the unmodified FIAMMA data-storage structure as long as the compressed address/data entries fit within the 96-bit maximum length restriction for compressed FIAMMA entries. The hardware required to implement the behaviour shown in the previous listing is shown in FIG. 17.

The preferred embodiment contains only a single 96-bit right shifter rather than the separate right and left shifters shown in the code above. The single shifter design prepends bit_ptr zeroes to the input compressed data aligning it correctly so the compressed entry abuts rather than overlaps the previous entry contained in the upper compressed entry register. The OR function allows the compressed entry to be copied into the register. In the event that the compressed data fills the upper register completely (96-bits) or exceeds 96 bits and straddles the boundary with the lower entry register, the logic generates a write signal for the external memory which causes the upper compressed register contents to be written to the 96-bit wide external memory. At the same time the lower compressed register contents are copied into the upper compressed register and the lower compressed register is zeroed. Finally as the upper compressed register contents are written to external memory the entry_ptr register is incremented so that the next time the upper compressed register contents will not overwrite the contents of the external memory location.

In order to keep track of how many bits have been filled in the upper compressed register the bit_ptr register is updated each time a compressed entry is abutted to the upper compressed register contents. In the case that the abutted entry does not fill all 96-bits of the upper compressed register the bit_ptr has an offset equal to the length of the compressed entry added to it. In the case the abutted entry exactly fills all 96 bits of the upper compressed register the bit_ptr is reset to zero so that the next compressed entry is copied into the upper bits of the upper compressed register, starting from the MSB and working to the right for len bits. Finally in the case that the compressed entry straddles into the lower compressed register the bit_ptr start position for the next compressed entry to be abutted is set to the length of the straddling section of the compressed entry. Again whereas 96-bit is used throughout the preferred embodiment there is no reason why any arbitrary width of memory could not be used in the event 96-bits width is unsuitable from the system design point of view.

### FIAMMA Matrix Decompression Logic

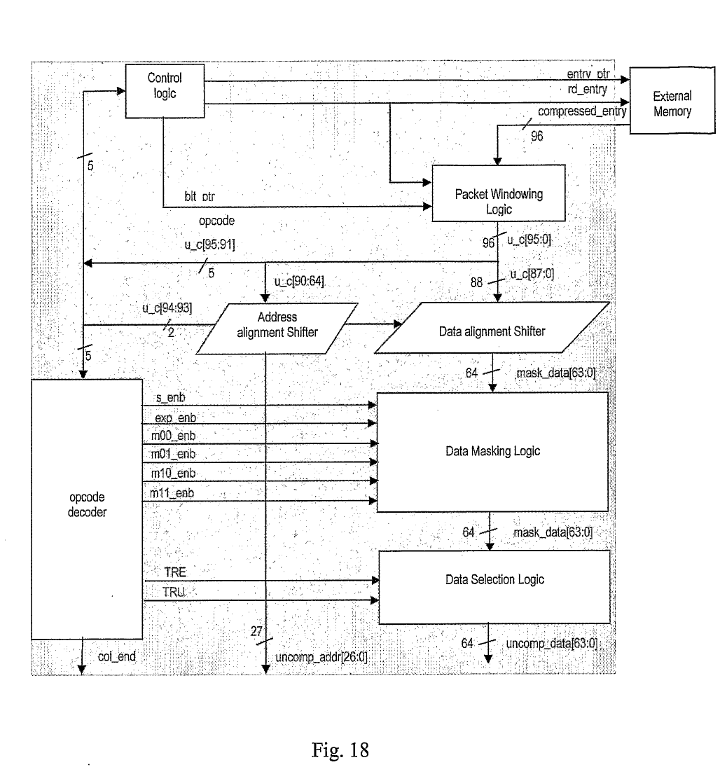

Referring to FIG. 18, as in the case of the data-compression path, decompression is performed in a streaming manner on the compressed packets as they are read in 96-bit sections from external memory. Performing decompression in a streaming fashion allows decompression to be performed in a single pass without having to first read data into a large buffer memory.

As can be seen the decompression path consists of control logic which advances the memory read pointer (entry_ptr) and issues read commands to cause the next 96-bit word to be read from external memory into the packet-windowing logic. This is followed by address and data alignment shifters, the address shifter correctly extracts the delta-address and the data alignment shifter correctly aligns the sign, exponent and mantissa for subsequent data masking and selection under the control of the opcode decoder.

### Packet-Windowing Logic

In order to ensure that the opcode can be properly decoded in all cases a 192-bit window must be maintained which straddles the boundary between the present 96-bit packet being decoded and the next packet so the opcode can always be decoded even if it straddles the 96-bit boundary. The windowing mechanism is advantageous to the proper functioning of the decompression logic as the opcode contains all of the information required to correctly extract the address and data from the compressed packet. The pseudocode for the packet-windowing logic is shown below.

Packet Windowing Pseudocode

1> available = (96 − bit_ptr);
2> if (available<96) {
3> u_c = (entries[entry_ptr]<<(96−available)) |
(entries[entry_ptr+1]>>available);
4> }
5> else {
6> u_c = entries[entry_ptr];
7> }

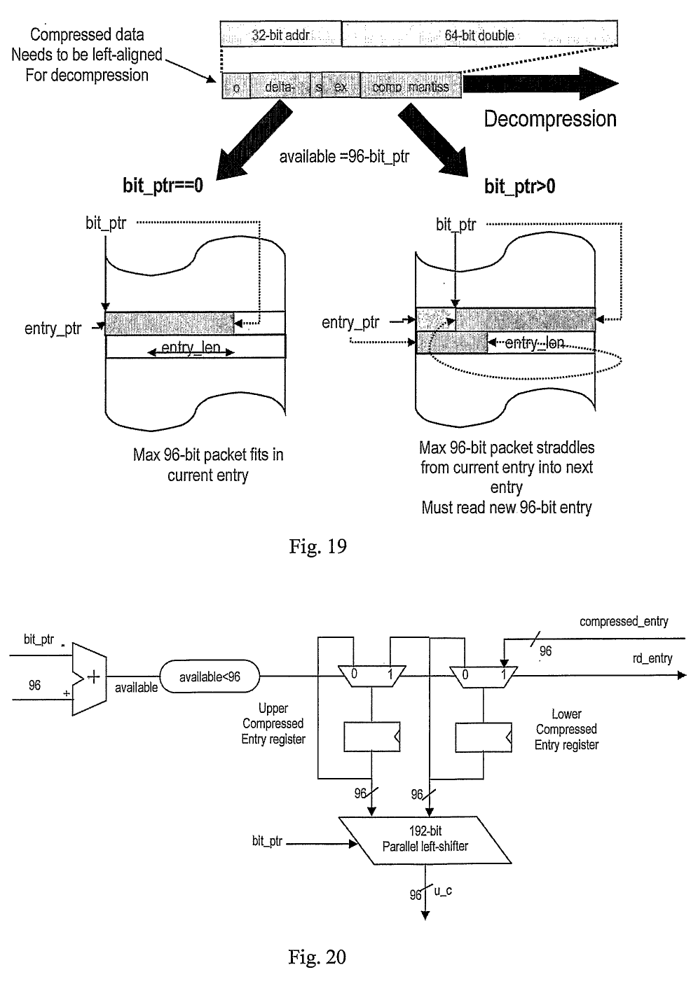

The decompression logic shown in works by moving a 96-bit window over the compressed data in the fiamma data-structure as the maximum opcode/addr/data packet length is always 96-bits in the compressed format so the next 96 bits is always guaranteed to contain a compressed fiamma packet as shown in FIG. 19.

The implementation of the packet-windowing logic is shown in FIG. 20. The design consists of a comparator which detects if the codeword straddles two 96-bit compressed words in memory. In the event a straddle is detected a new data word is read from memory from the location pointed to by entry_ptr+1 and the data-window is advanced, otherwise the current data-window around entry_ptr is maintained in the two 96-bit registers. The contents of the two 96-bit registers are then concatenated into a single 192-bit word which is shifted by bit positions to the left in order that the opcode resides in the upper 5 bits of the extracted 96-bit field so the decompression process can begin. The reason for the left-shift is obvious from FIG. 19.

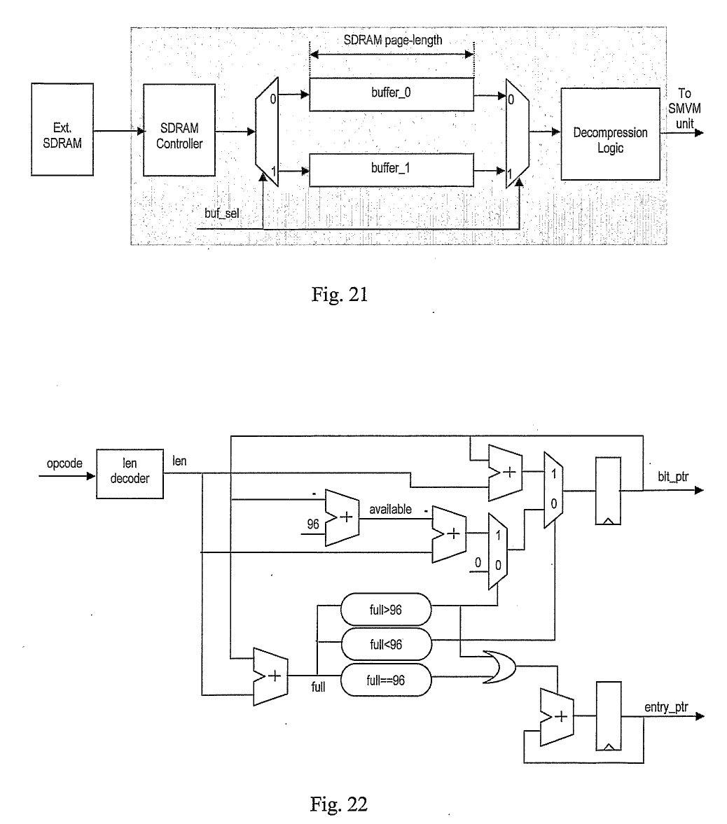

The entry_ptr+1 location can also be pre-fetched into a buffer in order to eliminate any delay which might otherwise occur in reading from external memory. The length of any such buffer if tuned to the page-length of the external memory device would maximise the throughput of the decompression path. In practice two buffers would be used where one is pre-fetching while the other is in use, thus minimizing overhead and maximizing decompression throughput. A possible implementation of the pre-fetch buffer subsystem is shown in FIG. 21.

### Decompression Control Logic

In order for decompression to proceed correctly it must adjust the entry_ptr pointer which points to the current 96-bit compressed word being operated on, and the bit_ptr pointer to the beginning of the next opcode within that word. In order to correctly adjust these pointers the length of the compressed word starting at location bit_ptr in the current compressed entry must be determined using the opcode field pointer to by bit_ptr. A simple look-up table shown below generates the len value used in the decompression control logic.

Decompression Length Decoder

| opcode | M | AL | | ML | | a_len | s_len | m_len | len |
|---|---|---|---|---|---|---|---|---|---|
| VAM | 0 | 1 | 1 | 1 | 1 | 27 | 12 | 52 | 96 |
| | 0 | 1 | 0 | 1 | 1 | 19 | 12 | 52 | 88 |
| | 0 | 0 | 1 | 1 | 1 | 11 | 12 | 52 | 80 |
| | 0 | 0 | 0 | 1 | 1 | 3 | 12 | 52 | 72 |
| | 0 | 1 | 1 | 1 | 0 | 27 | 12 | 39 | 83 |
| | 0 | 1 | 0 | 1 | 0 | 19 | 12 | 39 | 75 |
| | 0 | 0 | 1 | 1 | 0 | 11 | 12 | 39 | 67 |
| | 0 | 0 | 0 | 1 | 0 | 3 | 12 | 39 | 59 |
| | 0 | 1 | 1 | 0 | 1 | 27 | 12 | 26 | 70 |
| | 0 | 1 | 0 | 0 | 1 | 19 | 12 | 26 | 62 |
| | 0 | 0 | 1 | 0 | 1 | 11 | 12 | 26 | 54 |
| | 0 | 0 | 0 | 0 | 1 | 3 | 12 | 26 | 46 |
| | 0 | 1 | 1 | 0 | 0 | 27 | 12 | 13 | 57 |
| | 0 | 1 | 0 | 0 | 0 | 19 | 12 | 13 | 49 |
| | 0 | 0 | 1 | 0 | 0 | 11 | 12 | 13 | 41 |
| | 0 | 0 | 0 | 0 | 0 | 3 | 12 | 13 | 33 |
| TRU | 1 | 1 | 1 | 0 | 0 | 27 | 1 | 0 | 33 |
| | 1 | 1 | 0 | 0 | 0 | 19 | 1 | 0 | 25 |
| | 1 | 0 | 1 | 0 | 0 | 11 | 1 | 0 | 17 |
| | 1 | 0 | 0 | 0 | 0 | 3 | 1 | 0 | 9 |
| TRE | 1 | 1 | 1 | 0 | 1 | 27 | 12 | 0 | 44 |
| | 1 | 1 | 0 | 0 | 1 | 19 | 12 | 0 | 36 |
| | 1 | 0 | 1 | 0 | 1 | 11 | 12 | 0 | 28 |
| | 1 | 0 | 0 | 0 | 1 | 3 | 12 | 0 | 20 |
| CLU | 1 | 1 | 1 | 1 | 0 | 27 | 0 | 0 | 32 |
| | 1 | 1 | 0 | 1 | 0 | 19 | 0 | 0 | 24 |
| | 1 | 0 | 1 | 1 | 0 | 11 | 0 | 0 | 16 |
| | 1 | 0 | 0 | 1 | 0 | 3 | 0 | 0 | 8 |

The len value is then used to update the bit_ptr and entry_ptr values as shown below.

Decompression Control Pseudocode

1> available = (96 − bit_ptr);
2> full = len + bit_ptr;
3> if (full > 96) {
4> entry_ptr++;
5> bit_ptr = (len − available);
6> }
7> else if (full == 96) {
8> entry_ptr++;
9> bit_ptr = 0;
10> }
11> else {
12> bit_ptr += len;
13> }

The hardware required to implement the pseudocode description is shown in FIG. 22.

### Address-Alignment Shifter

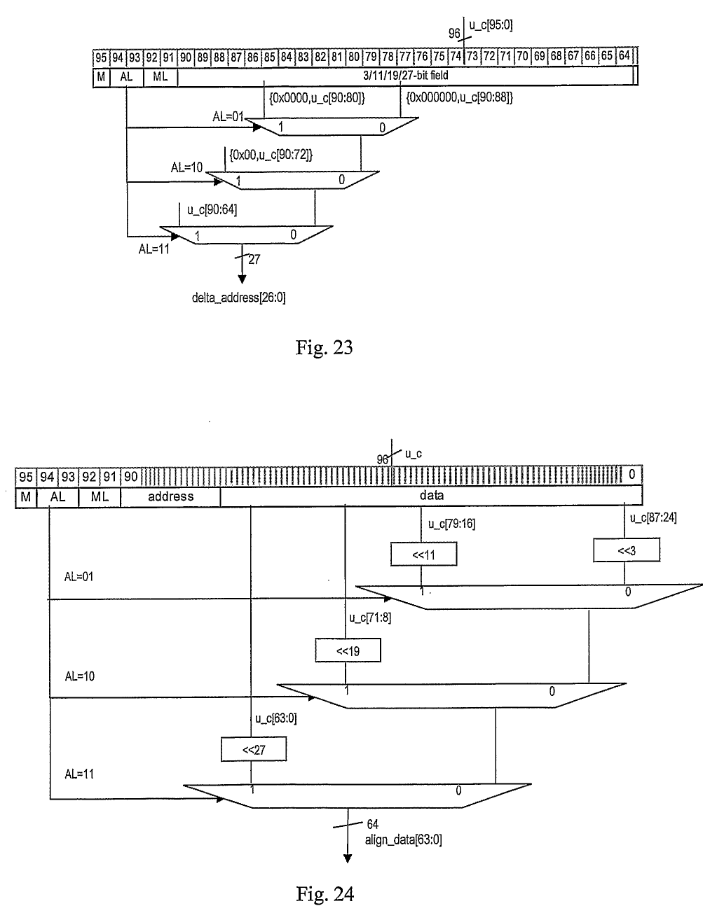

The address-field is decompressed by decoding the AL sub-field of the opcode which always resides in the upper 5 bits of u_c[95:0], the parallel shifter having performed a normalization shift to achieve this objective. The logic required to extract the address from the compressed entry u_c is shown in FIG. 23.

Once the delta-address information has been correctly aligned it must converted back to an absolute address by adding the appropriate column or base address offset as shown in FIG. 8.

### Data-Alignment Shifter

In order to correctly prepare the data for extraction a shift must be applied to normalise it so the sign-bit appears at bit 63 of the possible compressed data word as shown in the table below. The normalization shift is controlled by the AL field in the 5-bit opcode attached to each compressed entry in the FIAMMA data-structure.

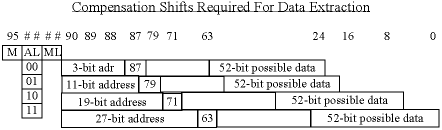

The data alignment shift logic shown in FIG. 24 consists of 3 multiplexers and a small decoder which implements the alignment shifts required. The actual shifts are implemented by wiring the multiplexer inputs appropriately to the source u_c bus.

### Data Masking Logic

In order to correctly turn the compressed data back into valid IEEE floating-point values the trailing bits in the compressed data portion of the packet must be first masked off so the next packet(s) in the compressed word can be ignored. The masking signals are derived from the opcode as shown below.

Opcode Decoder Truth-Table

| M | AL | | ML | | opcode | VAM | TRE | TRU | CLU | col_end | s_enb | exp_enb | m00_enb | m01_enb | m10_enb | m11_enb |
|---|---|---|---|---|---|---|---|---|---|---|---|---|---|---|---|---|
| 0 | x | x | 1 | 1 | VAM | 1 | 0 | 0 | 0 | 0 | 1 | 1 | 1 | 1 | 1 | 1 |
| 0 | x | x | 1 | 0 | | 1 | 0 | 0 | 0 | 0 | 1 | 1 | 1 | 1 | 1 | 0 |
| 0 | x | x | 0 | 1 | | 1 | 0 | 0 | 0 | 0 | 1 | 1 | 1 | 1 | 0 | 0 |
| 0 | x | x | 0 | 0 | | 1 | 0 | 0 | 0 | 0 | 1 | 1 | 1 | 0 | 0 | 0 |
| 1 | x | x | 0 | 1 | TRE | 0 | 1 | 0 | 0 | 0 | 1 | 1 | 0 | 0 | 0 | 0 |
| 1 | x | x | 0 | 0 | TRU | 0 | 0 | 1 | 0 | 0 | 1 | 0 | 0 | 0 | 0 | 0 |
| 1 | x | x | 1 | 0 | CLU | 0 | 0 | 0 | 1 | 1 | 0 | 0 | 0 | 0 | 0 | 0 |

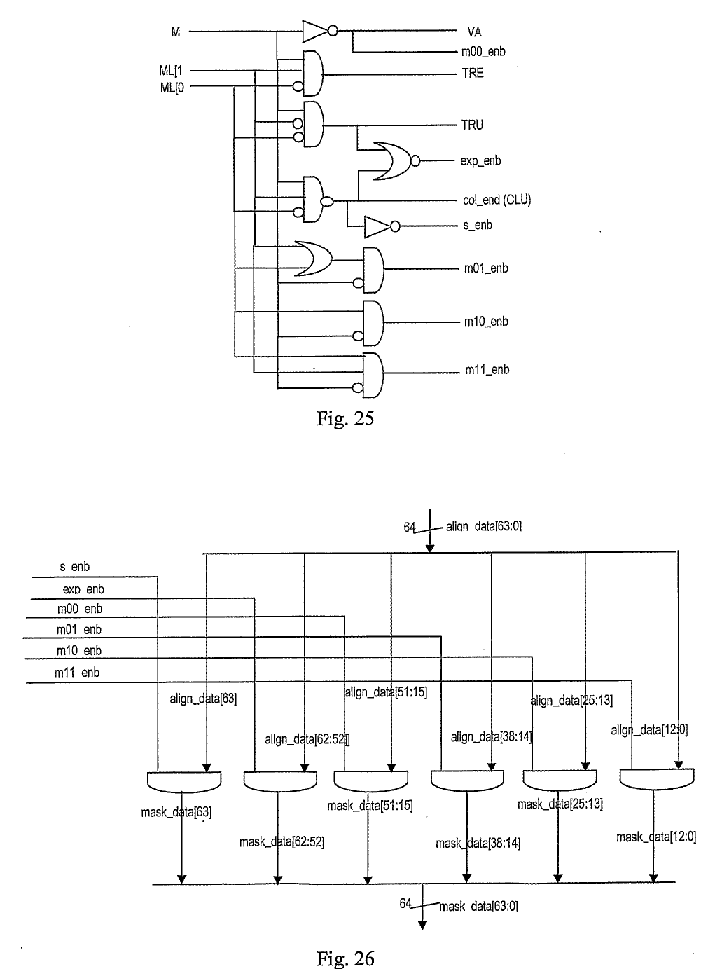

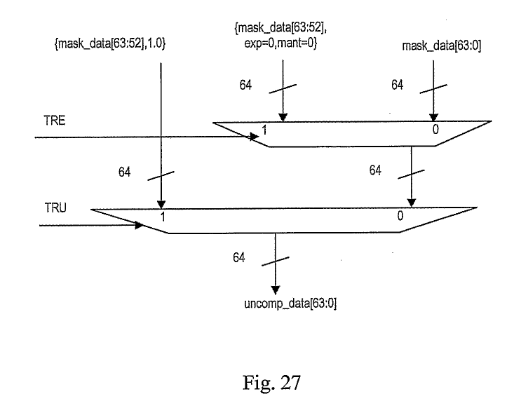

The logic shown in FIG. 25 allows the correct sign, exponent and data-masking signals to be generated. These signals in turn control AND gates which gate on and off the various sub-fields of the compressed data packet according to the opcode truth-table.

The data-masking logic controlled by the decompression data-masking decoder is shown in FIG. 26, and consists of a series of parallel AND gates controlled by the masking signals.

### Data Decompression Selection Logic

The final selection logic allows special patterns for trivial +/1s (TRU opcode) and trivial exponents (TRE) to be multiplexed in, or the masked mantissa to be muxed in depending on whether the active opcode. In the case of a TRE opcode all of the mantissa bits are set to zero, and in the case of the TRU opcode only the sign bit is explicitly stored and the exponent and mantissa corresponding to 1.0 in IEEE format are multiplexed in to recreate the original 64-bit compressed data.

### Compression Address-Range & Data-Shift Tuning

The distribution of delta-address lengths seen by statistical analysis of the matrix database showed many of the address displacements were very short, for instance column address displacements were on the order of a bit or two and the fact that even locally within rows data tends to be clustered. For this reason two alternate address-length range encodings corresponding to the opcode AL field were modelled as shown below.

Opcode Address-Length (AL) Encoding

| | 11 | 10 | 01 | 00 |
|---|---|---|---|---|
| AL_enc_1 | 27 | 24 | 16 | 8 |
| AL_enc_2 | 27 | 19 | 11 | 3 |

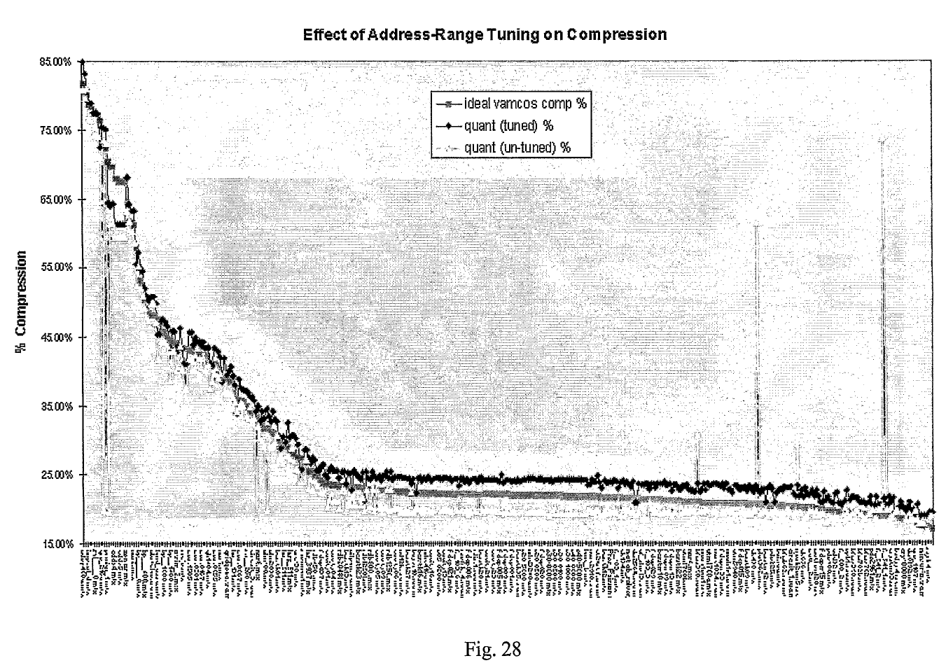

Simulation showed that the AL_enc_{—}2 encoding scheme increased the average compression achieved across the entire matrix database by approximately 3% as shown in FIG. 28. The reason for this improvement in terms of average compression is the number of 3-bit displacements in the matrix database is quite high, and quantizing them to 8-bit displacements using the AL_enc_{—}1 scheme is wasteful in terms of storage.

The full extent of how the compression ratio trades off against implementation cost has still to be fully investigated, however there is a mechanism for supporting such tuning. As was previously seen a total of 4 opcodes from the 32 possible codes are reserved. By using these opcodes to download a table of shift-codes corresponding to the AL and ML encodings at the end of each column from the host would allow the ranges of the shifts actually implemented to be varied on a column by column basis rather than being hardwired into the design. The incremental hardware cost would be eight 6-bit registers to hold the AL and ML encodings and some additional complexity in the decoder alignment shifters which would no longer work in bytes but rather in individual bit shifts.

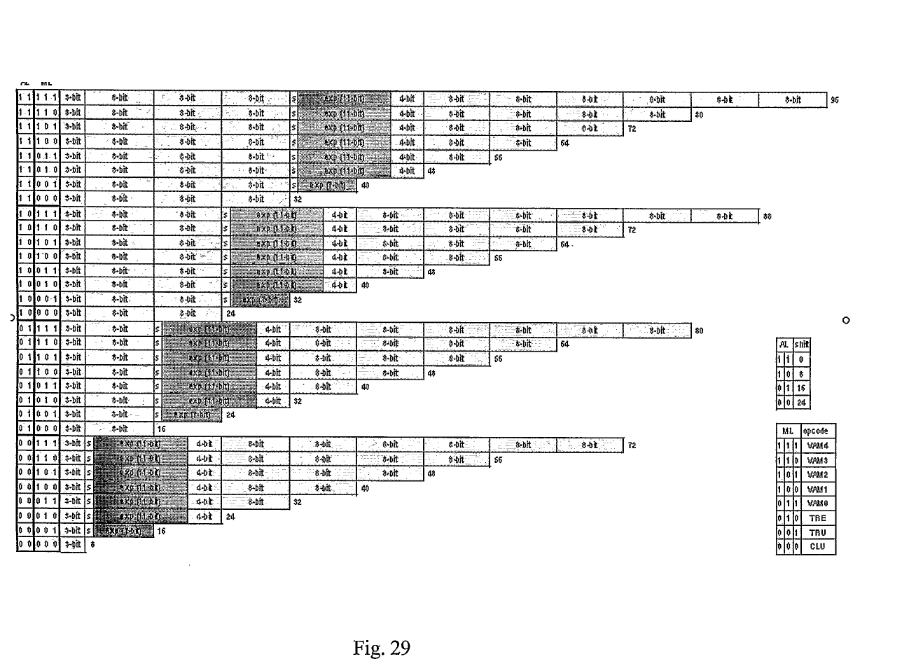

An alternate Opcode/addr/data format table which could be used to simplify the design of both encode and decode logic at the expense of some loss in terms of the amount of compression achieved is shown in FIG. 29.

This alternate encoding would have the benefit of simplifying all alignment shifters to byte shifts but at the expense of a loss in compression efficiency.

### FIAMMA Datapath Parallelism

In the prior SPAR architecture the end of a column was denoted by the insertion of a zero into the normally non-zero matrix storage, resulting in N×96 additional bits of storage, where N is the number of columns in the matrix. More importantly the inclusion of zeroes in the matrix in the SPAR architecture also leads to a reduction in memory bandwidth and either a floating-point unit stalls or is allowed to perform a multiply by zero NOP.

Parallel CLU and VAM packets

| | | |
|---|---|---|
| CLU | VAM11 | 96 |

| | | |
|---|---|---|
| CLU | VAM11 | 88 |

| | | |
|---|---|---|
| CLU | VAM11 | 80 |

In the FIAMMA architecture, however given the offset between column addresses is on the order of a bit or two, it is almost certain that a Column-Update or CLU packet will fit into a 96-bit compressed entry along with a full 64-bit double, either exactly into 96-bits or with some room to spare as shown in the table above. In this case assuming the decompression logic can decompress the CLU and VAM (Variable Address/Mantissa) packets in a single clock cycle no such stall occurs as the column address update can take place in parallel with the SMVM MAC operation.

Parallel VAM Packets

| VAM01 | | | VAM01 | 92 |
|---|---|---|---|---|
| | VAM00 | VAM00 | 66 | |

Equally as shown in the table above it is possible that two VAM packets can occur in a single 96-bit compressed word in the body of a column, assuming that mantissae can be compressed to 26-bits and that the offsets between row addresses in a column are short. It is even possible for ten trivial +/−1 entries to be compressed into a single 96-bit compressed word, or four trivial exponents to be packed into the same size word as shown in the table below.

Parallel TRE or TRU Packets

| | | | | | | | | | | | |
|---|---|---|---|---|---|---|---|---|---|---|---|
| TRU | TRU | TRU | TRU | TRU | TRU | TRU | TRU | TRU | TRU | TRU | 88 |

| | | | | |
|---|---|---|---|---|
| TRE | TRE | TRE | TRE | 80 |

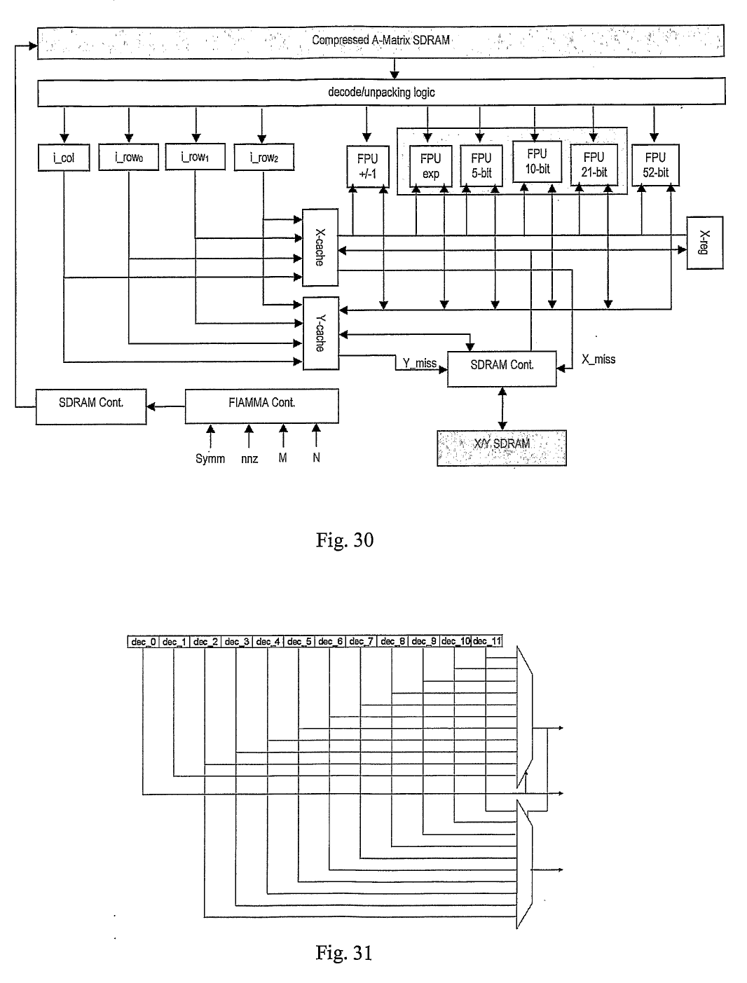

Given the nature of the compression mechanism there is ample possibility for these and other combinations of compressed data to occur within a 96-bit entry or worst case assuming the double-precision non-zero entries cannot be compressed there will be some inherent parallelism (perhaps five 64-bit non-zero entries and corresponding addresses for every 4 memory accesses assuming 25% compression) given that even on such matrices a significant level of address-compression is achievable. An architecture capable of dealing with this kind of parallelism would require several FPUs, multi-port caches and separate row and column address registers as shown in FIG. 30.

The main problems with this architecture are the design of multi-port X and Y caches and the design of a decompression block capable of decompressing multiple operand/address pairs in a single memory cycle. The issue with the decode of multiple opcodes in a single cycle is that the process is inherently sequential given that the first opcode in a 96-bit window must be decoded first in order to determine the location of the second opcode etc. While theoretically possible it is impractical to implement 96 parallel decompression blocks, however if we modify the compression scheme so as to limit the points at which opcodes can occur to byte boundaries as shown in FIG. 29, we need now only implement twelve parallel opcode decoders (96=8×12).

These parallel decoders can then use a selection scheme similar to that used in carry-select adders to select the actual starting positions of the new opcodes based on based on the initial known position however this type of approach would be excessively complex if full look-ahead across all 12 decoder outputs were implemented, requiring 12 opcode decoders, one 11:1 mux, one 10:1 mux, one 9:1 mux, one 8:1 mux, one 7:1 mux, one 6:1 mux, one 5:1 mux, one 4:1 mux, one 3:1 mux and one 2:1 mux (outline shown in FIG. 31). On top of this the full decompression path would also need to be fully or partially duplicated up to 12 times. Obviously it would be possible to implement a reduced look-ahead scheme but this would run the risk of producing no speed up for a large fraction of the time so this option seems impractical.

Given that multiple operands can be fetched in a single 96-bit memory access it makes sense to exploit this parallelism by including multiple FPUs assuming they can be kept supplied with data by the A-matrix decompression block and memory interface, as well as the X and Y caches. In the case of the A matrix decompression path the decompression takes place in a sequential fashion as each opcode must be decoded in turn in order to find the next. This means the only option for speeding up the decompression process is to run the decompression logic faster (over to 10× faster in that ten TRU packets can fit in a single 96-bit word) than the memory interface in order to fully decompress all of the operands in a single external memory interface cycle.

The same holds for the FPU datapath and caches where the easiest option is to run a single FPU and it's associated caches as up to 10× the frequency of the external memory bus. In practice this option has several advantages in that in modern process technologies clock frequencies of 3-4 GHz can be supported for double-precision operations, whereas the external bus runs at perhaps 1/10 of that rate i.e. 100 s of MHz. In this case the power dissipation and noise caused by running the FPU and caches at this high rate could be mitigated by counting the number of operands to be processed in a cycle and passing this parameter along with the 1-10 pieces of data from the decompression unit to the FPU. The FPU controller could then use a counter to process the 1-10 values specified by the decompression block and then switch into a low-power mode until the next batch of operands has been decompressed.

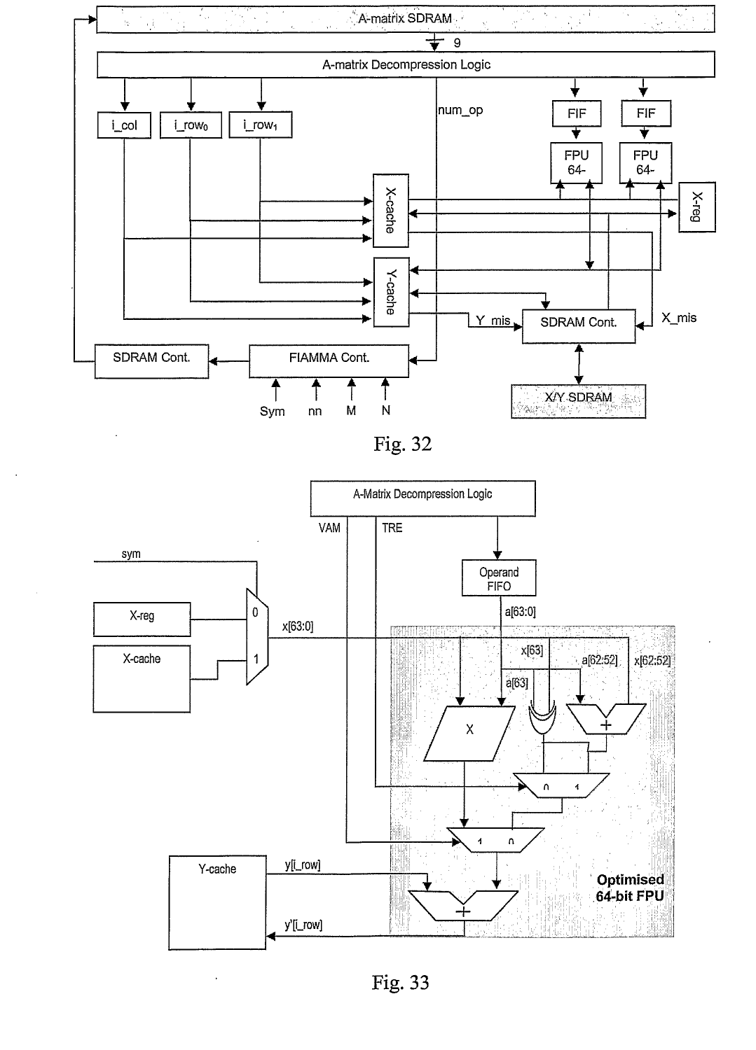

A good compromise given that this architecture might be implemented in technologies such as Field Programmable Gate-Arrays (FPGAs) as well as custom silicon would be to include two FPUs which can run at 5× the external bus frequency respectively as shown in FIG. 32. This reduces the cache design problem to dual-ported cache designs which are easily implemented using standard dual-port RAMs which are commonly available semiconductor process technologies and even FPGAs. The two FPUs can be kept fully loaded under a variety of load conditions given that many of the solution methods such as cg require symmetric matrices. By taking advantage of being able to run the FPU at a higher rate if required this allows the peak processing rate of 10× the memory interface speed to be delivered when required.

Within the datapath it is also possible to use the TRU and TRE data in reduced format i.e. without re-expanding to 64-bit double-precision numbers by including low-latency optimized multipliers in parallel with the full double-precision units. The advantage of this approach is that at the expense of some additional parallel hardware to support these operations an overall reduction in the time taken to compute the complete matrix-vector product could be achieved. In the case of a multiply by +/−1 (TRU) the optimized multiplier is an Exclusive-OR gate to invert the sign of the entry read from X and in the case of the TRE operand only the exponents of the A entry and X need be added as the mantissa of A is zero. The modified data-path including the optimized multipliers is shown in FIG. 33. In this case early completion of the multiplication can be taken account of in the FIAMMA controller by tracking the TRE, TRU, VAM and CLU signals corresponding to each MAC operation.

### FIAMMA SMVM to Dot-Product Interface

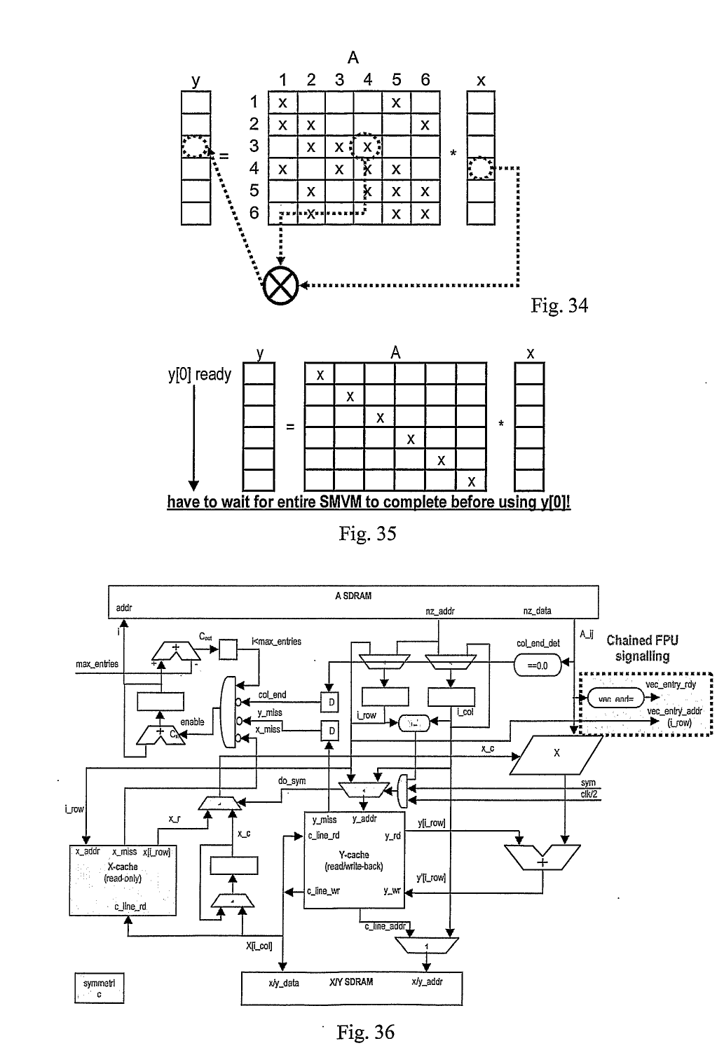

There is the possibility to start the dot-product, or in principle other linear algebra algorithms which utilise vector elements from an SMVM multiplication once all of the calculations corresponding to that element have completed. In the case of a matrix stored in unsymmetric or symmetric format this occurs when the last entry contributing to an element of the solution-vector y in the A matrix has been processed by the SMVM unit as shown in FIG. 34.

From the example shown all of the elements contributing to y[3] (3rd row entry in the y solution vector) complete in column 4 of the SMVM operation. By keeping track of which A matrix columns contribute to which y-vector entries it is possible to perform 2 passes through the uncompressed source matrix in the compression process in order to tag at the end of a column which y solution-vector vector entry(ies) complete at the end of that column. The benefit of being to signal intermediate vector entries are ready for further processing is best illustrated by looking at a banded matrix where only very few entries occur around the diagonal of the matrix. In this case nnz-1 cycles (where nnz is the number of entries in a diagonal matrix) could elapse between the first entry of the solution vector being computed and the result actually being processed by the next unit in the floating-point pipeline, for instance in the case of the cg algorithm this would be a dot-product. A simple example is given in FIG. 35.

In a conventional sparse-matrix multiplier and storage format there is no means to tag matrix entries in order to be able to compare and signal parallel units that incremental outputs are available for subsequent processing. In conventional GPP-based software implementations of linear algebra operations such tagging and comparison is not used nor would it be practical to implement, meaning that each linear algebraic operation must be treated as an atomic operation by the system hardware and software. By atomic it is intended that the complete operation must finish elaborating all data before subsequent processing can proceed.

### Matrix-Data Tagging Mechanism

One way of tagging sparse-matrix entries is to record the entry_ptr value corresponding to each vector address each time a particular vector address is encountered. In this way after the complete matrix has been downloaded to the accelerator a last_update array exists which contains the last update of that vector. This is possible in that the order in which the matrix is processed in an SMVM is always the same and entry_ptr values always occur in ascending order. An example of data tagging for an unsymmetric matrix is shown below.

SMVM Unsymmetric Matrix-Data Tagging Example

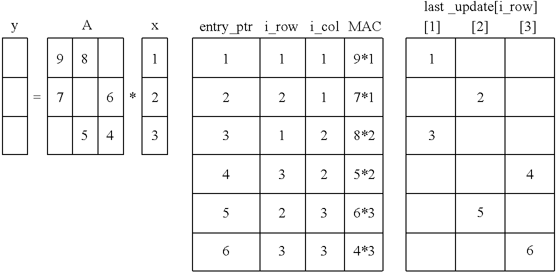

An example of data tagging for a symmetric matrix is shown in FIG. 8. As can be seen two updates to the last_update RAM occur for element [2,1] of the A-matrix because symmetric MAC element occurs at position diagonally opposite A[i_row,i_col], and causes y[i_col] to be updated. Supporting this requirement necessitates the use of a dual-port memory to hold the last_update[] array and to support parallel FPUs in the SMVM logic.

Symmetric SMVM Matrix Tagging

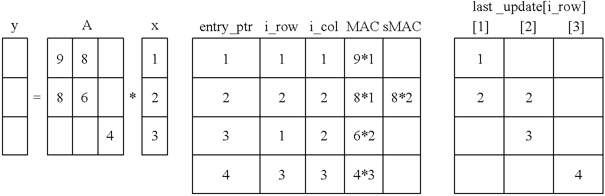

The last_update array can then be downloaded to the accelerator following the matrix and can be checked in parallel with the MAC operations computed based on each matrix-entry in order to flag the chained FPU if the entry_ptr for the SMVM loop is equal to the last_entry_ptr retrieved from the last_update[i_row] as shown in the listing below.

SMVM-Chained FPU Vector-Element Ready Signaling

1> while (i < A.max_entries) {
2> a_ij = A.k[i];
3> if (a_ij==0) { // check for end of column
4> i_col = A.r[i];
5> x_c = x[i_col]; // copy memory->reg and reuse
6> }
7> else { // process row entries from column
8> i_row = A.r[i];
9> if ((i_row != i_col) && symmetric) {
10> y[i_col] += a_ij * x[i_row]; // symmetric MAC
11> vec_ent_rdy_s = (last_update[i_col]==i);
12> }
13> else {
14> y[i_row] += a_ij * x_c; // normal MAC
15> vec_ent_rdy = (last_update[i_row]==i);
16> }
17> }
18> i++;
19> }

A disadvantage with this scheme is whereas it requires only a single pass through the sparse matrix to determine the last updates for each vector element, it required an N-element array (the vector is N elements long) to be stored and down-loaded to the accelerator at the end of the sparse-matrix download. It also requires an m-bit wide comparator in the SMVM unit to compare last_update[i_row] entries against the counter (i) used in the SMVM control-loop.

### PREFERRED EMBODIMENT

The preferred embodiment of the tag-insertion scheme for unsymmetric matrices is shown below.

-Matrix Tag-Insertion Pseudocode

```
1>  // do first pass to find last vector references
2>  v_end = new int[M];
3>  for (i=0; i<nz; i++) {
4>  if (A[i].val != 0.0) {
5>  if (this->sym) {
6>  v_end[A[i].col] = i; // iteration @ which vector[col] was
        updated
7>  }
8>  else  v_end[A[i].row] = i;  //  iteration  @
      which  vector[row] was updated
9>  }
10>  }
11>  // second pass copies entries and tags vector references
12>  j = A[0].col;
13>  for (i=0; i<nz; i++) {
14>  if (j!=A[i].col) {  // end of column ... insert zero into A.k
      to denote end of column
15>  this->entries[max_entries].r = A[i].col; // enter data into
      sparta data-structure
16>  this->entries[max_entries].k = 0.0;  // enter data into
      sparta data- structure
17>  this->max_entries++;  // sparta has a 96-bit entry
      for the end of each column
18>  }
19>  if (A[i].val != 0.0) {  // NB: check that only non-zero
      values are copied into sparta data structure
i.   //  as otherwise incorrect operation will result when
      sparta smvm interprets
ii.  //  zero entries which are NOT pointers to rew row/col indices
20>  if (v_end[A[i].row]==i) {  // found last update to vector-entry
21>  this->entries[max_entries].r = A[i].row | 0x80000000; // last
      entry for vector so tag it
22>  }
23>  else {
24>  this->entries[max_entries].r = A[i].row; // store index of
      next row ... not last entry so no tag
25>  }
26>  this->entries[max_entries].k = A[i].val; // copy value into sparta
27>  this->max_entries++;  // sparta has a 96-bit entry
      for the end of each column
28>  }
29>  j = A[i].col; // update column address
30>  }
```

The preferred embodiment of the tag-decoding scheme would be to tag the actual entry in the A-matrix rather than placing tags at the end of the column in the matrix. This entry-tagging rather than column-tagging scheme has the advantage that only a single bit in the opcode field would be required to tag a data-entry in the A-matrix. If a second pass through the matrix elements is possible before down-loading to the accelerator then a vec_end bit can be inserted into the compressed sparse-matrix entries in the second pass through the matrix when last_update[i_row] is equal to the loop counter value (i).

This scheme requires no additional storage for the last_update[] array which is not down-loaded to the accelerator, and the comparator width decreases from m-bits to 1 bit wide. By including a comparator in the SMVM control-logic to detect whether a vector-completion bit has been set the SMVM unit can signal an associated dot-product unit that a particular solution-vector entry is ready for processing allowing the dot-product or other post-processing operation to proceed in parallel with the remainder of the SMVM operation. An implementation of the data-tagging scheme is shown below. The corresponding SMVM tag-detection and signalling logic is shown in FIG. 36.

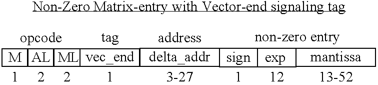

As can be seen from the block diagram a detector is included in the SMVM unit which detects if the vec_end bit has been set for a particular matrix entry. If the vec_end entry is true for a particular entry this signal is broadcast to the chained floating-point unit(s) along with the corresponding address at which to find the vector data entry in memory. If desired the vector entry itself could also be broadcast to the chained FPU(s) at the cost of some additional wiring. An additional refinement of this scheme would be to detect if the row-entry in the x vector is zero (zeroes can occur dynamically) and in this case a complete column of the SMVM multiplication could be skipped thus speeding up the SMVM calculation.

Some additional optimisations can be performed to produce a combined SMVM and Dot-Product (DP) unit with support for symmetric storage and processing as well as SMVM-DP chaining (vector-pipelining). The optimised pseudocode for the combined SMVM-DP unit is shown below.

Optimised SMVM-DP Pseudocode

1> while (i < >max_entries) {
2> a_ij = A.entries[i].k;
3> if (a_ij==0.0) {
4> if (col_dot) {
5> y[i_col] = y_c;
6> dp += y_c * s_c;
7> }
8> i_col = A.entries[i].r;
9> y_c = y[i_col];
10> x_c = x[i_col];
11> s_c = s[i_col];
12> }
13> else {
14> i_row = A.entries[i].r & 0x7fffffff;
15> row_dot = ((A.entries[i].r & 0x80000000) &&
A.sym==false) ? true : false;
16> y_r = y[i_row];
17> x_r = x[i_row];
18> s_r = s[i_row];
19> do_uppr= ((i_row!=i_col)&&A.sym);
20> do_diag= ((i_row==i_col)&&A.sym);
21> if (do_diag) y_c += (a_ij * x_c); // symmetric
22> else {
23> y_r_{—} = y_r + (a_ij * x_c); // non-symmetric
24> if (row_dot) dp += y_r_{—} * s_r;
25> y[i_row] = y_r_;
26> }
27> if (do_uppr) y_c += (a_ij * x_r);
28> }
29> i++;
30> }

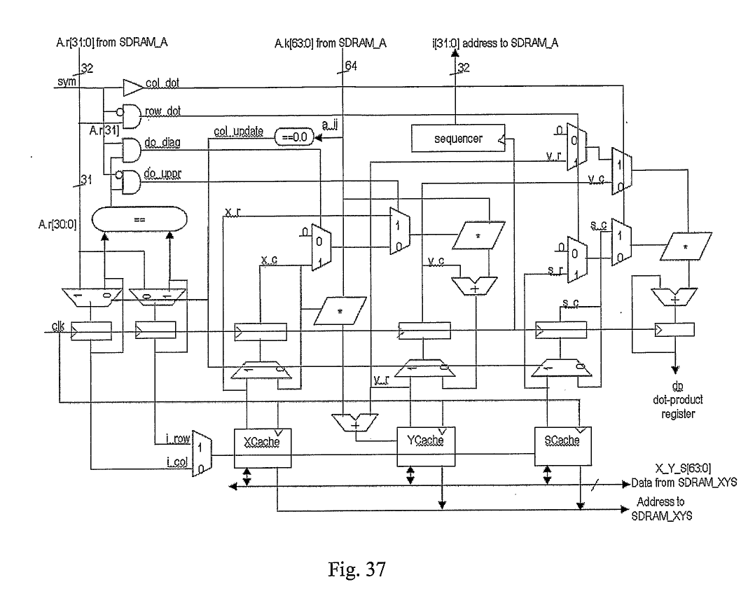

An advantage of the behaviour shown in the pseudocode is that the cache bandwidth and miss-rates are reduced by the addition of a y-register (y_c) in parallel with the y-cache. This y_c register is used for the symmetric portion of the matrix (above the diagonal) and allows the normal (unsymmetric) portion of the matrix to be processed independently of the symmetric portion. The y_c register is complemented by the presence of an X-cache for the symmetric calculations in much the same way as the Y-cache is used to support unsymmetric calculations in conjunction with the x_c register. An additional s_c register and S-cache and an additional MAC are provided to support dot-product processing and multiplexers are used to switch between symmetric and unsymmetric dot-product processing using the embedded tags decoded from the A.r address entries in combination with the sym input which switches the entire SMVM-DP unit between symmetric and unsymmetric modes for each matrix to be processed. The block-diagram for the optimised SMVM-DP unit is shown in FIG. 37.

The X, Y and S-caches can be optimized in terms of number of lines and number of entries per line in order that their combined miss-rates are low enough to share a single external SDRAM interface for a minimum cost implementation as input-output pins and packaging for silicon integrated circuits are costly. The X, Y and S caches can be implemented in many ways, however in practice direct-mapped caches have been employed in this embodiment in order to reduce implementation cost. These same direct-mapped caches have been found to be adequate in terms of performance and also allow a novel feature to be implemented which reduces the start-up time of the overall combined SMVM-DP unit as shown in the next section.

### FIAMMA SMVM Vector Memory Initialization

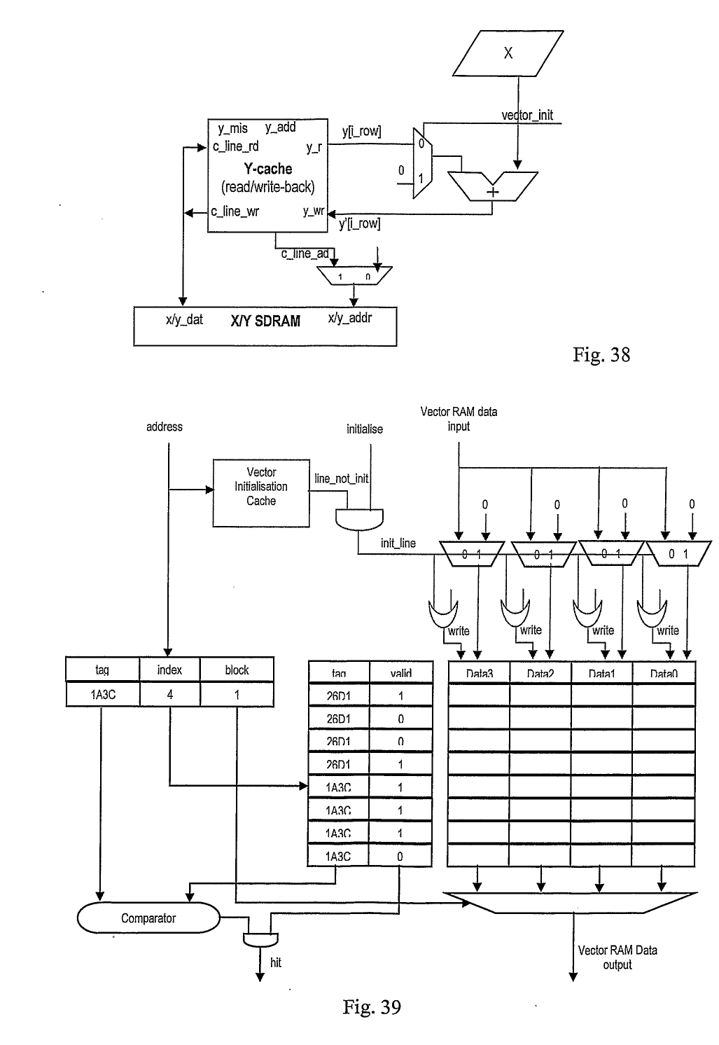

In GPP based implementations of SMVM or iterative solvers the solution vector memory, whether internal or external to the processor has to be initialised in some way. Typically this is done by writing the initialisation value(s) to each entry of the solution vector in memory which takes at least N cycles in the case the solution vector contains N rows. In order to minimise this overhead some parallelism is required, however in a conventional GPP parallelism produces on reduction in the time between vector initialisation in memory and the point at which the SMVM operations can begin. One method of initialising the cache contents would be to use a multiplexer under the control of an initialisation input to initialise each of the vector elements individually as shown in FIG. 38. This scheme has the disadvantage of requiring an initialisation bit for each vector entry, ie N bits corresponding to N rows.

In order to reduce the start-up time between vector initialisation and SMVM in the FIAMMA architecture it is proposed that the properties of the write-back cache be exploited in a novel manner. A traditional write-back-cache on encountering a cache-miss first writes back the line for which the miss occurred into vector memory if the dirty flag corresponding to that line is set, before loading the new cache-line from vector memory and proceeding. Thus in a write-back cache each dirty line represents the master copy of the data in the entire FIAMMA system. This property of write-back caches can be taken advantage of in memory initialisation of vectors (or in fact matrices) by loading the cache-line with the initialisation value, say zero and setting the dirty-flag corresponding to that line. In this way when the dirty line is written back to vector memory on the next cache miss for that line or when the cache is eventually flushed at the end of the SMVM operation, the effect is as if the external memory had actually been initialised directly. By including a complete row of multiplexers in the cache a complete cache-line can be initialised in a single cycle as shown in FIG. 39.

This scheme has the advantage of requiring an initialisation bit per cache-line rather than per vector entry and requires fewer cycles to perform the initialisation while simplifying the initialisation logic which keeps track of which parts of the vector are initialised and which are not. In order to prevent cache-lines from being initialised more than once a second auxiliary vector initialisation cache is required with one bit per cache-line in order to ensure that the vector cache is not initialised more than once as this could potentially overwrite valid data in the cache and/or vector memory. The initialisation process consists of two steps; first the vector initialisation-cache is checked to see if the initialisation bit corresponding to the current vector cache line has already been set. If the bit has not been set the initialisation-cache sets the line_not_init signal high and the corresponding vector cache-line is set to zero by generating a write signal for each memory in the cache line and setting the input to be written to 0 or any other initialisation value via a multiplexer controlled by the init_line signal, otherwise the vector cache line has already been initialised and need not be initialised again.

### FIAMMA Macro-Parallelism

Several techniques exist for partitioning large sparse matrices onto parallel processors. Mondriaan for example is program that can be used to partition a rectangular sparse matrix, an input vector, and an output vector for parallel sparse matrix-vector multiplication. The program is based on a recursive bi-partitioning algorithm that cuts the matrix horizontally and vertically, while reducing the amount of communication and spreading both computation and communication evenly over the processors.

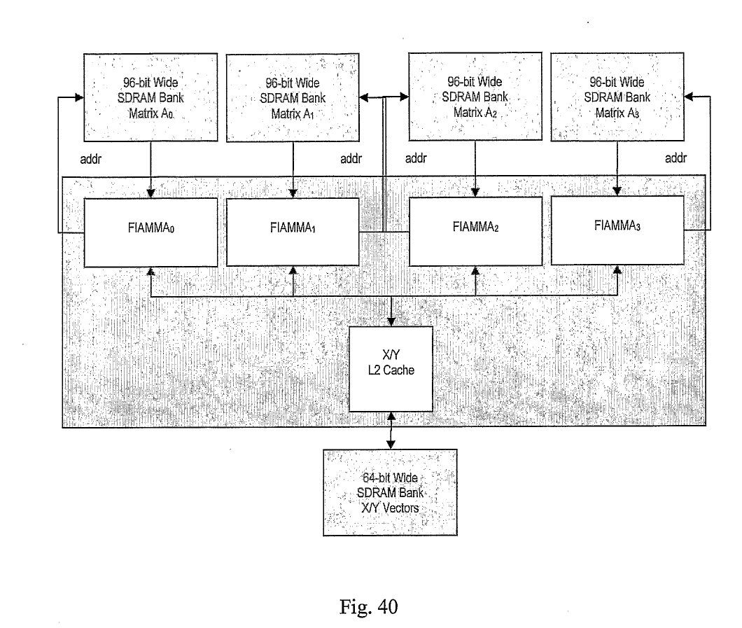

Such techniques are beyond the scope of this work however if such a package were used to partition a large matrix across multiple FIAMMA processors some additional hardware would be required for an efficient hardware implementation. Specifically if each FIAMMA processor had access to a separate A matrix memory corresponding to it's partitioned subset of the large A matrix, all of the X and Y vectors would need to be shared and updated across the array of FIAMMA processors. A practical method for achieving this would be to use a second level (L2) cache which could interface to several FIAMMA processors on one side and to a common X/Y vector memory on the other side. A block diagram of such a two-level cache mechanism is shown in FIG. 40.

In this system using a write-back cache mechanism would entail that if an L1 Cache miss occurs for any of the Y caches then all Y-caches throughout the cache hierarchy containing copies of that Y-vector data would have to be refreshed directly before any further updates to the local copies of the Y-cache entries could be made. The X-caches which are read-only would require no modification. In practice if the matrix partitioning algorithm has done its job well the number of occasions on which such a multi-level cache miss can occur will be infrequent.

It will be appreciated that the invention improves upon the prior art by:
Providing support for symmetric matrices to reduce memory storage and bandwidth requirements and increase Floating-Point Operations per Second (FLOPs) performance.
Providing streaming sparse-matrix compression and decompression again reducing storage requirements and memory bandwidth while increasing FLOPs performance.
Providing an automated means of tuning the data and address compression tables such as to obtain maximum matrix compression.
Providing multiple Floating-Point Units (FPUs) which are optimized to the mix of compressed and uncompressed non-zero data entries which are fed by the matrix decompression unit in such a way as to increase FLOPs throughput without increasing memory bandwidth requirements.
Vector Cache/Memory initialisation logic to reduce the start-up time before beginning useful SMVM operations, thus increasing the FLOPs and external memory bandwidth requirements.

The invention is not limited to the embodiments described but may be varied in construction and detail. For example, some or all of the components may be implemented totally in software, the software performing the method steps described above.

1-20. (canceled)

21. A matrix by vector multiplication processing system comprising:
a compression engine for receiving and dynamically compressing a stream of elements of a matrix; in which the matrix elements are clustered, and in which the matrix elements are in numerical floating point format;
a memory for storing the compressed matrix;
a decompression engine for dynamically decompressing elements retrieved from the memory; and
a processor for dynamically receiving decompressed elements from the decompression engine, and comprising a vector cache, and multiplication logic for dynamically multiplying elements of the vector cache with the matrix elements.

22. The matrix by vector multiplication processing system as claimed in claim 21, wherein the processor comprises a cache for vector elements to be multiplied by matrix elements above a diagonal and a separate cache for vector elements to be multiplied by matrix elements below the diagonal, and a control mechanism for multiplying a single matrix element by a corresponding element in one vector cache and separately by a corresponding element in the other vector cache.

23. The matrix by vector multiplication processing system as claimed in claim 22, wherein the vector elements are time-division multiplexed to a multiplier.

24. The matrix by vector multiplication processing system as claimed in claim 22, wherein the multiplication logic comprises parallel multipliers for simultaneously performing both multiplication operations on a matrix element.

25. The matrix by vector multiplication processing system in claim 22, wherein the processor comprises a multiplexer for clocking retrieval of the vector elements

26. The matrix by vector multiplication processing system as claimed in claim 21, wherein the compression engine and the decompression logic are circuits within a single integrated circuit

27. The matrix by vector multiplication processing system as claimed in claim 21, wherein the compression engine performs matrix element address compression by generating a relative address for a plurality of clustered elements.

28. The matrix by vector multiplication processing system as claimed in claim 21, wherein the compression engine performs matrix element address compression by generating a relative address for a plurality of clustered elements; and wherein the compression engine keeps a record of row and column base addresses, and subtracts these addresses to provide a relative address.

29. The matrix by vector multiplication processing system as claimed in claim 21, wherein the compression engine performs matrix element address compression by generating a relative address for a plurality of clustered elements; and wherein the compression engine left-shifts an address of a matrix element to provide a relative address.

30. The matrix by vector multiplication processing system as claimed in claim 21, wherein the compression engine performs matrix element address compression by generating a relative address for a plurality of clustered elements; and wherein the compression engine left-shifts an address of a matrix element to provide a relative address; and wherein the left-shifting is performed according to the length of the relative address.

31. The matrix by vector multiplication processing system as claimed in claim 21, wherein the compression engine performs matrix element address compression by generating a relative address for a plurality of clustered elements; and wherein the compression engine left-shifts an address of a matrix element to provide a relative address; and wherein the compression engine comprises a relative addressing circuit for shifting each address by one of a plurality of discrete options.

32. The matrix by vector multiplication processing system as claimed in claim 21, wherein the compression engine performs matrix element address compression by generating a relative address for a plurality of clustered elements; and wherein the compression engine left-shifts an address of a matrix element to provide a relative address; and wherein the compression engine comprises a relative addressing circuit for shifting each address by one of a plurality of discrete options; and wherein the relative addressing circuit comprises a length encoder having one of a plurality of outputs decided according to address length.

33. The matrix by vector multiplication processing system as claimed in claim 21, wherein the compression engine performs matrix element address compression by generating a relative address for a plurality of clustered elements; and wherein the compression engine left-shifts an address of a matrix element to provide a relative address; and wherein the compression engine comprises a relative addressing circuit for shifting each address by one of a plurality of discrete options; and wherein the relative addressing circuit comprises a plurality of multiplexers implementing hardwired shifts.

34. The matrix by vector multiplication processing system as claimed in claim 21, wherein the compression engine compresses a matrix element by eliminating trailing zeroes from each of the exponent and mantissa fields.

35. The matrix by vector multiplication processing system as claimed in claim 21, wherein the compression engine compresses a matrix element by eliminating trailing zeroes from each of the exponent and mantissa fields; and wherein the compression engine comprises means for performing the following steps:
recognizing the following patterns in the non-zero data entries:
+/−1s which can be encoded as an opcode and sign-bit only,
power of 2 entries consisting of a sign, exponent and all zero mantissa, and
entries which have a sign, exponent and whose mantissa contains trailing zeroes; and
performing the following operations:
forming an opcode by concatenating opcode_M, AL and ML bit fields,
forming the opcode, compressed delta-address, sign, exponent and compressed mantissa into a compressed entry, and
left-shifted the entire compressed entry in order that the opcode of the compressed data resides in bit N-1 of an N-bit compressed entry.

36. The matrix by vector multiplication processing system as claimed in claim 21, wherein the compression engine comprises inserts compressed elements into a linear array in a bit-aligned manner.

37. The matrix by vector multiplication processing system as claimed in claim 21, wherein the decompression engine comprises packet-windowing logic for maintaining a window which straddles at least two elements.

38. The matrix by vector processing system as claimed in claim 37, wherein the decompression logic comprises a comparator which detects if a codeword straddles two N-bit compressed words in memory, and logic for performing the following operations:
in the event a straddle is detected a new data word is read from memory from the location pointed to by entry_ptr+1and the data-window is advanced, otherwise the current data-window around entry_ptr is maintained in the two N-bit registers, and
concatenating the contents of the two N-bit registers into a single 2N-bit word which is shifted by bit positions to the left in order that the opcode resides in the upper set of bits of the extracted N-bit field so the decompression process can begin.

39. The matrix by vector multiplication processing system as claimed in claim 21, wherein the decompression engine comprises data masking logic for masking off trailing bits of packets.

40. The matrix by vector multiplication processing system as claimed in claim 21, wherein the decompression engine comprises data decompression logic for multiplexing in patterns for trivial exponents.
